(19) United States
(12) Patent Application Publication
(10) Pub. No.: US 2015/0061979 A1
(43) Pub. Date: Mar. 5, 2015

(54) DISPLAY PANEL, METHOD OF DRIVING THE SAME, AND ELECTRONIC APPARATUS

(71) Applicant: Sony Corporation, Tokyo (JP)

(72) Inventors: Hideyuki SUZUKI, Kanagawa (JP); Yoshifumi MIYAJIMA, Kanagawa (JP); Kazukuni TAKANOHASHI, Tokyo (JP); Kiyohiro SAITO, Kanagawa (JP)

(21) Appl. No.: 14/457,192

(22) Filed: Aug. 12, 2014

(30) Foreign Application Priority Data
Aug. 29, 2013 (JP) 2013-177535

(51) Int. Cl. G09G 3/32

(52) U.S. Cl. CPC G09G 3/3208
USPC 345/76

(57) ABSTRACT

A display unit includes: a display section including a plurality of unit pixels; and a display drive section configured to generate a plurality of clock signals and supply the clock signals to the display section, the clock signals including two or more clock signals with phases different from one another.

### CROSS REFERENCES TO RELATED APPLICATIONS

The present application claims priority to Japanese Priority Patent Application JP 2013-177535 filed in the Japan Patent Office on Aug. 29, 2013, the entire content of which is hereby incorporated by reference.

### BACKGROUND

The present disclosure relates to a display panel that displays an image, a method of driving such a display panel, and an electronic apparatus including such a display panel.

Recently, in the field of display panels that display an image, display panels (organic EL (Electro Luminescence) display panels) using, as light-emitting devices, current drive type optical devices with light emission luminance changeable according to a value of a current flowing therethrough, for example, organic EL devices have been developed for commercialization. Unlike liquid crystal devices and the like, the organic EL devices are self-luminous devices; therefore, in the organic EL devices, a light source (a backlight) is not necessary. Accordingly, the organic EL display panels have characteristics such as higher image visibility, lower power consumption, and higher response speed of a device, compared to liquid crystal display panels needing a light source.

For example, Japanese Unexamined Patent Application Publication No. 2012-32828 discloses a so-called active matrix display panel in which a thin film transistor (TFT) is provided to each pixel to control light emission of an organic EL device in each pixel. This display panel includes a plurality of gate lines extending along a horizontal direction and a plurality of data lines extending along a vertical direction, and respective pixels are disposed around respective intersections of the gate lines and the data lines. Then, pixels in a line are selected line by line, based on a gate line signal, and an analog pixel voltage is written to the selected pixels.

### SUMMARY

Typically, it is desirable that display panels have high image quality, and further enhancement in image quality is expected.

It is desirable to provide a display panel capable of enhancing image quality, a driving method, and an electronic apparatus.

According to an embodiment of the present disclosure, there is provided a display panel including: a display section including a plurality of unit pixels; and a display drive section configured to generate a plurality of clock signals and supply the clock signals to the display section, the clock signals including two or more clock signals with phases different from one another.

According to an embodiment of the present disclosure, there is provided a driving method including: generating a plurality of clock signals, the clock signals including two or more clock signals with phases different from one another; and supplying the plurality of clock signals to the display section including a plurality of unit pixels.

According to an embodiment of the present disclosure, there is provided an electronic apparatus provided with a display panel and a control section, the control section configured to perform operation control on the display panel, the display panel including: a display section including a plurality of unit pixels; and a display drive section configured to generate a plurality of clock signals and supply the clock signals to the display section, the clock signals including two or more clock signals with phases different from one another. The electronic apparatus may correspond to, for example, a television, a digital camera, a personal computer, a video camera, a mobile terminal unit such as a cellular phone, or the like.

In the display panel, the driving method, and the electronic apparatus according to the embodiments of the present disclosure, a plurality of clock signals are generated by the display drive section, and are supplied to the display section. The plurality of clock signals include two or more clock signals with phases different from one another.

In the display panel, the driving method, and the electronic apparatus according to the embodiments of the present disclosure, a plurality of clock signals including two or more clock signals with phases different from one another are generated; therefore, image quality is allowed to be enhanced.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the technology, and are incorporated in and constitute a part of this specification. The drawings illustrate embodiments and, together with the specification, serve to explain the principles of the technology.

FIG. 1 is a block diagram illustrating a configuration example of a display unit according to a first embodiment of the present disclosure.

FIG. 2 is a block diagram illustrating a configuration example of a display drive section and a display section illustrated in FIG. 1.

FIG. 3 is a timing waveform diagram illustrating an operation example of the display drive section illustrated in FIG. 2.

FIG. 4 is an explanatory diagram illustrating a configuration example of a data signal.

FIG. 5 is a block diagram illustrating a configuration example of a pixel illustrated in FIG. 2.

FIG. 6 is a state transition diagram illustrating an operation example of a control section illustrated in FIG. 2.

FIG. 7 is an explanatory diagram illustrating an operation example of each pixel illustrated in FIG. 2.

FIG. 8 is a timing waveform diagram illustrating an operation example of each pixel illustrated in FIG. 2.

FIG. 9 is a block diagram illustrating a configuration example of a display drive section and a display section according to a modification example of the first embodiment.

FIG. 10 is a timing waveform diagram illustrating an operation example of the display drive section illustrated in FIG. 9.

FIG. 11 is a timing waveform diagram illustrating an operation example of a display drive section according to another modification example of the first embodiment.

FIG. 12 is a timing waveform diagram illustrating an operation example of a display drive section according to still another modification example of the first embodiment.

FIG. 13 is a timing waveform diagram illustrating an operation example of a display drive section according to a further modification example of the first embodiment.

FIG. 14 is a block diagram illustrating a configuration example of a display drive section and a display section according to a still further modification example of the first embodiment.

FIG. 15 is a timing waveform diagram illustrating an operation example of the display drive section illustrated in FIG. 14.

FIG. 16 is a block diagram illustrating a configuration example of a pixel illustrated in FIG. 14.

FIG. 17 is a block diagram illustrating a configuration example of a pixel according to a still modification example of the first embodiment.

FIG. 18 is a block diagram illustrating a configuration example of a display unit according to a second embodiment.

FIG. 19 is a block diagram illustrating a configuration example of a display drive section and a display section illustrated in FIG. 18.

FIG. 20 is an explanatory diagram illustrating a configuration example of a data signal.

FIG. 21 is a block diagram illustrating a configuration example of a pixel illustrated in FIG. 19.

FIG. 22 is a timing waveform diagram illustrating an operation example of a phase comparison section illustrated in FIG. 19.

FIG. 23 is a block diagram illustrating a configuration example of a pixel according to a modification example of the second embodiment.

FIG. 24 is a block diagram illustrating a configuration example of a display drive section and a display section according to another modification example of the second embodiment.

FIG. 25 is a block diagram illustrating a configuration example of a pixel according to still another modification example of the second embodiment.

FIG. 26A is an explanatory diagram illustrating a configuration example of a data signal according to the still another modification example of the second embodiment.

FIG. 26B is an explanatory diagram illustrating another configuration example of the data signal according to the still another modification example of the second embodiment.

FIG. 27 is a block diagram illustrating a configuration example of a display drive section and a display section according to a modification example.

FIG. 28 is a block diagram illustrating a configuration example of a display drive section and a display section according to another modification example.

### DETAILED DESCRIPTION

Some embodiments of the present disclosure will be described in detail below referring to the accompanying drawings. It is to be noted that description will be given in the following order.

1. First Embodiment

2. Second Embodiment

### 1. First Embodiment

### Configuration Example

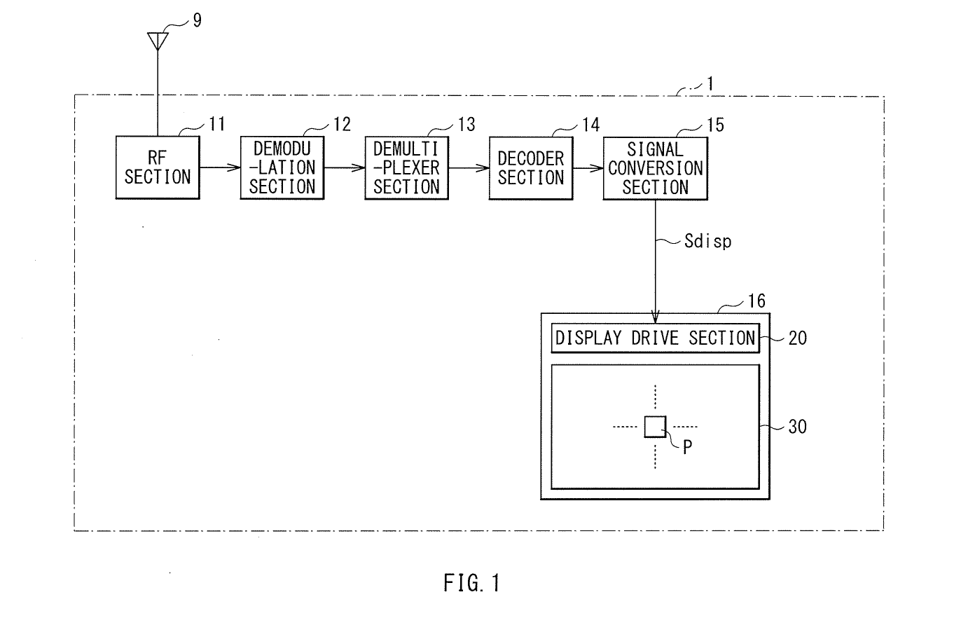

FIG. 1 illustrates a configuration example of a display unit according to a first embodiment. A display unit 1 is a television including a display panel that uses an LED (Light Emitting Diode) as a display device. It is to be noted that a display panel and a method of driving the same according to embodiments of the present disclosure are embodied by this embodiment, and will be also described below.

The display unit 1 includes a RF (Radio Frequency) section 11, a demodulation section 12, a demultiplexer section 13, a decoder section 14, a signal conversion section 15, and a display panel 16.

The RF section 11 is configured to perform processing such as down-converting on a broadcast wave (an RF signal) received by an antenna 9. The demodulation section 12 is configured to perform demodulation processing on a signal supplied from the RF section 11. The demultiplexer section 13 is configured to separate, into a video signal and an audio signal, a signal (a stream) that is supplied from the demodulation section 12 and is obtained by multiplexing the video signal and the audio signal.

The decoder section 14 is configured to decode a signal (the video signal and the audio signal) supplied from the demultiplexer section 13. More specifically, in this example, the signal supplied from the demultiplexer section 13 is a signal encoded in MPEG2 (Moving Picture Experts Group phase 2), and the decoder section 14 is configured to perform decoding on the signal.

The signal conversion section 15 is configured to perform format conversion of a signal. More specifically, in this example, a signal supplied from the decoder section 14 is a YUV format signal, and the signal conversion section 15 is configured to convert the format of the signal into a RGB format. Then, the signal conversion section 15 is configured to output, as an image signal Sdisp, the signal subjected to format conversion.

The display panel 16 is an active matrix display panel using an LED as a display device. The display panel 16 includes a display drive section 20 and a display section 30. The display drive section 20 is configured to drive the display section 30, based on the image signal Sdisp supplied from the signal conversion section 15. The display section 30 is configured to display an image, based on driving by the display drive section 20. The display section 30 includes a plurality of pixels P arranged in a matrix form. More specifically, as will be described later, the pixels P are arranged in a matrix of M pixels wide (horizontal) by N pixels high (vertical).

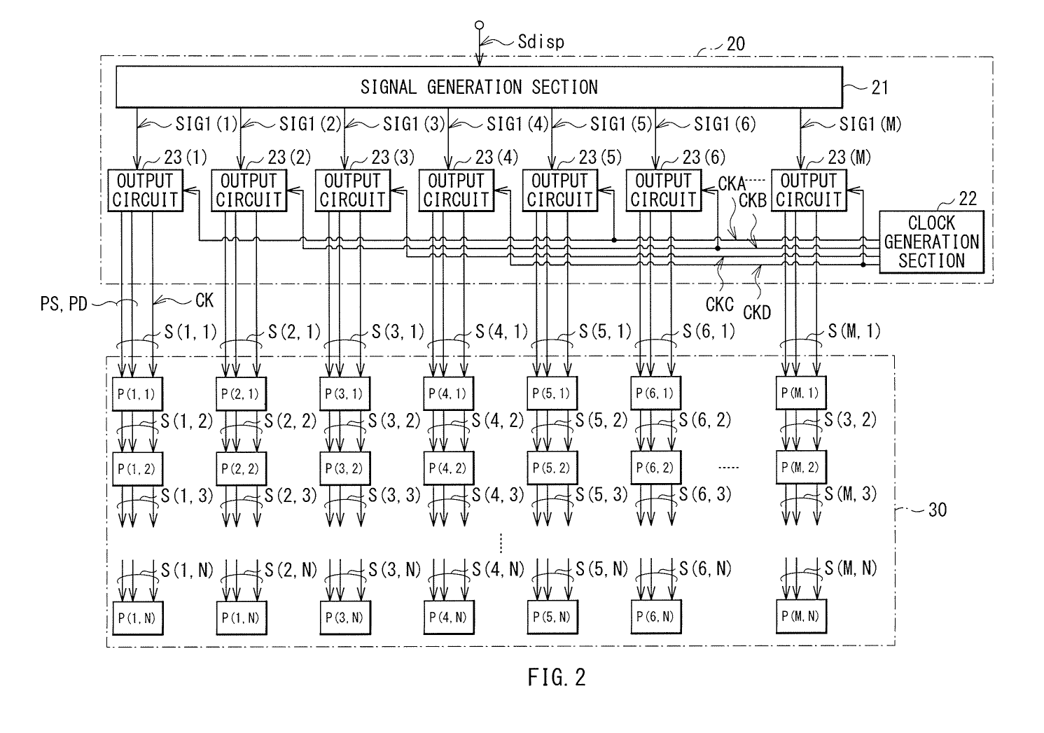

FIG. 2 illustrates a configuration example of the display drive section 20 and the display section 30.

The display drive section 20 includes a signal generation section 21, a clock generation section 22, and a plurality of output circuits 23(1) to 23(M). The signal generation section 21 is configured to generate and output a plurality of signals SIG1(1) to SIG1(M), based on the image signal Sdisp. The respective signals SIG1(1) to SIG1(M) correspond to respective M number of pixel columns of the display section 30, and include luminance data ID (that will be described later) of pixels P belonging to respective pixel columns. In this example, the clock generation section 22 is configured to generate clock signals CKA to CKD of four phases. The clock signals CKA and CKB are about 90° out of phase with each other, the clock signals CKB and CKC are about 90° out of phase with each other, the clock signals CKC and CKD are about 90° out of phase with each other, and the clock signals CKD and CKA are about 90° out of phase with each other. The output circuits 23(1) to 23(M) are configured to generate signals S(1, 1) to S(M, 1), based on the signals SIG1(1) to SIG1(M) and the clock signals CKA to CKD. The respective output circuits 23(1) to 23(M) are provided corresponding to the respective M number of pixel columns of the display section 30. In other words, the output circuits 23(1) to 23(M) are provided corresponding to the signals SIG1(1) to SIG1(M), respectively.

The signal generation section 21 supplies the signals SIG1(1) to SIG1(M) to corresponding output circuits 23(1) to 23(M), respectively. Then, the clock generation section 22 supplies one of the clock signals CKA to CKD to each of the output circuits 23(1) to 23(M). In this example, the clock generation section 22 supplies the clock signal CKA to the output circuits 23(1), 23(5), 23(9), and so on, supplies the clock signal CKB to the output circuits 23(2), 23(6), 23(10), and so on, supplies the clock signal CKC to the output circuits 23(3), 23(7), 23(11), and so on, and supplies the clock signal CKD to the output circuits 23(4), 23(8), 23(12), and so on.

Therefore, for example, the output circuit 23(1) may generate and output data signals PS(1, 1) and PD(1, 1) in synchronization with the clock signal CKA, based on the signal SIG1(1) and the clock signal CKA, and may output the clock signal CKA as a clock signal CK(1, 1), and then may supply the data signals PS(1, 1) and PD(1, 1) and the clock signal CK(1, 1) as a signal S(1, 1) to the display section 30. Moreover, for example, the output circuit 23(2) may generate and output data signals PS(2, 1) and PD(2, 1) in synchronization with the clock signal CKB, based on the signal SIG1(2) and the clock signal CKB, and may output the clock signal CKB as a clock signal CK(2, 1), and then may supply the data signals PS(2, 1) and PD(2, 1) and the clock signal CK(2, 1) as a signal S(2, 1) to the display section 30. Further, for example, the output circuit 23(3) may generate and output data signals PS(3, 1) and PD(3, 1) in synchronization with the clock signal CKC, based on the signal SIG1(3) and the clock signal CKC, and may output the clock signal CKC as a clock signal CK(3, 1), and then may supply the data signals PS(3, 1) and PD(3, 1) and the clock signal CK(3, 1) as a signal S(3, 1) to the display section 30. Furthermore, the output circuit 23(4) may generate and output data signals PS(4, 1) and PD(4, 1) in synchronization with the clock signal CKD, based on the signal SIG1(4) and the clock signal CKD, and may output the clock signal CKD as a clock signal CK(4, 1), and then may supply the data signals PS(4, 1) and PD(4, 1) and the clock signal CK(4, 1) as a signal S(4, 1) to the display section 30.

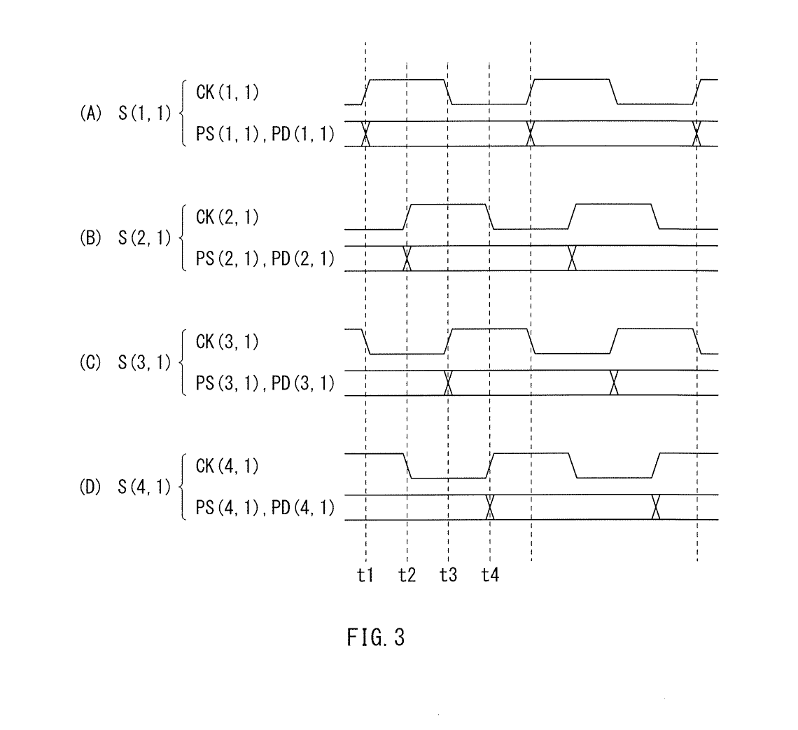

FIG. 3 illustrates a timing diagram of output signals from the output circuits 23(1) to 23(4), where parts (A), (B), (C), and (D) illustrate a waveform of the output signal S(1, 1) from the output circuit 23(1), a waveform of the output signal S(2, 1) from the output circuit 23(2), a waveform of the output signal S(3, 1) from the output circuit 23(3), and a waveform of the output signal S(4, 1) from the output circuit 23(4), respectively. In this example, the output circuits 23(1) to 23(4) operate, based on the clock signals CKA to CKD of four phases; therefore, the clock signal CK(1, 1) in the signal S(1, 1) is about 90° out of phase with the clock signal CK(2, 1) in the signal S(2, 1), the clock signal CK(2, 1) in the signal S(2, 1) is about 90° out of phase with the clock signal CK(3, 1) in the signal S(3, 1), the clock signal CK(3, 1) in the signal S(3, 1) is about 90° out of phase with the clock signal CK(4, 1) in the signal S(4, 1), and the clock signal CK(4, 1) in the signal S(4, 1) is about 90° out of phase with the clock signal CK(1, 1) in the signal S(1, 1). Then, the output circuit 23(1) transitions the data signals PS(1, 1) and PD(1, 1) on a rising edge of the clock signal CK(1, 1) (refer to the part (A) in FIG. 3), the output circuit 23(2) transitions the data signals PS(2, 1) and PD(2, 1) on a rising edge of the clock signal CK(2, 1) (refer to the part (B) in FIG. 3), the output circuit 23(3) transitions the data signals PS(3, 1) and PD(3, 1) on a rising edge of the clock signal CK(3, 1) (refer to the part (C) in FIG. 3), and the output circuit 23(4) transitions the data signals PS(4, 1) and PD(4, 1) on a rising edge of the clock signal CK(4, 1) (refer to the part (D) in FIG. 3).

Since the output circuits 23(1) to 23(4) operate, based on the clock signals CKA to CKD of four phases in such a manner, a transition timing t1 (refer to the part (A) in FIG. 3) for the data signals PS(1, 1) and PD(1, 1), a transition timing t2 (refer to the part (B) in FIG. 3) for the data signals PS(2, 1) and PD(2, 1), a transition timing t3 (refer to the part (C) in FIG. 3) for the data signals PS(3, 1) and PD(3, 1), and a transition timing t4 (refer to the part (D) in FIG. 3) for the data signals PS(4, 1) and PD(4, 1) are different from one another. Therefore, in the display unit 1, as will be described later, a possibility that each pixel P malfunctions is allowed to be reduced by spreading transition timings, and deterioration in image quality is allowed to be reduced.

The display section 30 includes a plurality of pixels P (pixels P(1, 1) to P(M, N) arranged in a matrix form. In other words, the pixels P are arranged in a matrix of M pixels wide (horizontal) by N pixels high (vertical). N number of pixels P (for example, pixels P(1, 1), P(1, 2), . . . , P(1, N)) arranged side by side in a vertical direction and configuring each pixel column are connected in a so-called daisy chain fashion. More specifically, for example, the display drive section 20 may supply the signal S(1, 1) (the data signals PS(1, 1) and PD(1, 1) and the clock signal CK(1, 1)) to the pixel P(1, 1) in a first stage of a leftmost pixel column. The pixel P(1, 1) generates a signal S(1, 2) (data signals PS(1, 2) and PD(1, 2) and a clock signal CK(1, 2)), based on the signal S(1, 1), and supplies the signal S(1, 2) to the pixel P(1, 2) subsequent to the pixel P(1, 1). The subsequent pixel P(1, 2) generates a signal S(1, 3) (data signals PS(1, 3) and PD(1, 3) and a clock signal CK(1, 3)), based on the signal S(1, 2), and supplies the signal S(1, 3) to the pixel P(1, 3) subsequent to the pixel P(1, 2). Subsequent pixels P(1, 3) to P(1, N−1) operate in a similar manner. Then, the pixel P(1, N) in a last stage receives a signal S(1, N) (data signals PS(1, N) and PD(1, N) and a clock signal CK(1, N)) generated by the pixel P(1, N−1) previous to the pixel P(1, N).

Hereinafter, the term “signal S” is used as one arbitrary signal of the signals S(1, 1) to S(M, N) as appropriate, the term “data signal PS” is used as one arbitrary signal of the data signals PS(1, 1) to PS(M, N) as appropriate, the term “data signal PD” is used as one arbitrary signal of the data signals PD(1, 1) to PD(M, N) as appropriate, and the term “clock signal CK” is used as one arbitrary signal of the clock signals CK(1, 1) to CK(M, N) as appropriate.

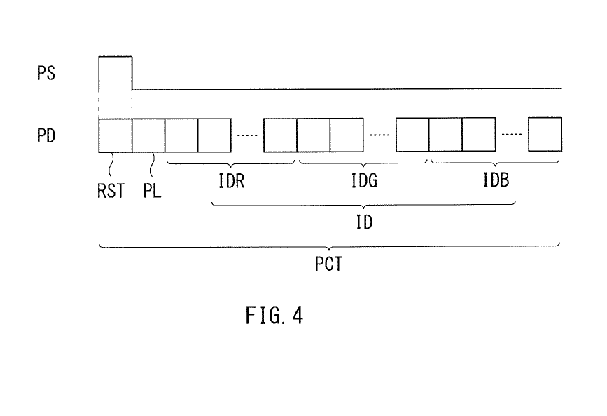

FIG. 4 illustrates a configuration example of the data signals PS and PD. FIG. 4 illustrates the data signals PS and PD for one pixel P. In other words, the display drive section 21 supplies the data signal PS and the data signal PD configured of N number of signals illustrated in FIG. 4 to the N number of pixels P connected in a daisy chain fashion. Hereinafter, the data signal PD for one pixel P may be also referred to as “pixel packet PCT”.

The data signal PD includes luminance data ID, a flag RST, and a flag PL. The luminance data ID is configured to define light emission luminance in each pixel P. The luminance data ID includes luminance data IDR indicating red (R) light emission luminance, luminance data IDG indicating green (G) light emission luminance, and luminance data IDB indicating blue (B) light emission luminance. In this example, each of the luminance data IDR, IDG, and IDB is a code of 12 bits. The flag RST is configured to indicate whether or not the pixel packet PCT is a first pixel packet PCT in each frame. More specifically, the flag RST is “1” in the first pixel packet PCT in each frame, and is “0” in other pixel packets PCT in that frame. The flag PL is configured to indicate whether or not the luminance data ID in the pixel packet PCT has been read by any one of the pixels P. More specifically, the flag PL is turned to “0” in a case where the luminance data ID has not yet been read by any of the pixels P, and is turned to “1” in a case where the luminance data ID has been read by any one of the pixels P. In this example, the flag RST, the flag PL, and the luminance data ID are arranged in this order in the pixel packet PCT.

The data signal PS is a signal that is turned to “1” in a case where the data signal PD indicates the flag RST, and is turned to “0” in other cases. In other words, the data signal PS is a signal that is turned to “1” at the start of each pixel packet PCT.

Each pixel P receives the data signals PS and PD and the clock signal CK from the pixel P previous thereto, and supplies the data signals PS and PD and the clock signal CK to the pixel P subsequent thereto. Then, each pixel P reads the luminance data IC for that pixel P from the data signal PD, and emits light with light emission luminance according to the luminance data ID.

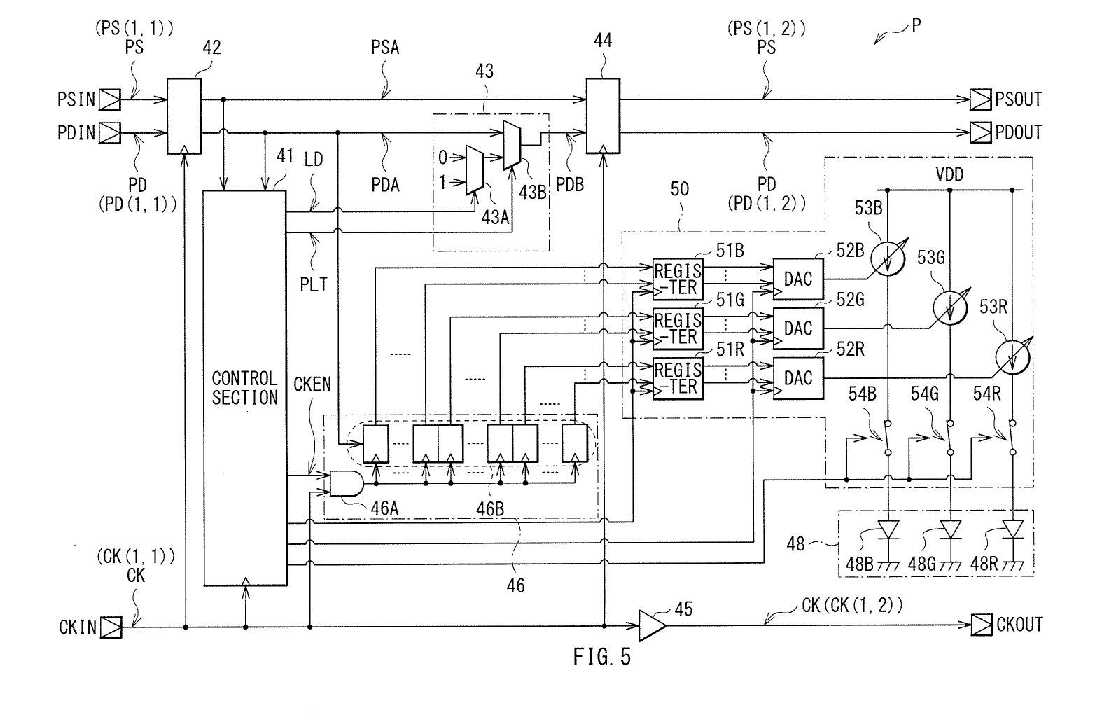

FIG. 5 illustrates a configuration example of the pixel P. The pixel P includes flip-flops 42 and 44, a control section 41, a selector section 43, a buffer 45, a memory section 46, a drive section 50, and a light emission section 48. It is to be noted that, for convenience of description, the pixel P (1, 1) will be described below as an example; however, other pixels P are similar to the pixel P(1, 1).

The pixel P(1, 1) generates and outputs the signal S(1, 2), based on the signal S(1, 1). More specifically, the pixel P(1, 1) generates the data signals PS(1, 2) and PD(1, 2) and the clock signal CK(1, 2), based on the data signal PS(1, 1) input to an input terminal PSIN thereof, the data signal PD(1, 1) input to an input terminal PDIN thereof, and the clock signal CK(1, 1) input to an input terminal CKIN thereof. Then, the pixel P(1, 1) outputs the data signal PS(1, 2), the data signal PD(1, 2), and the clock signal CK(1, 2) from an output terminal PSOUT, an output terminal PDOUT, and an output terminal CKOUT thereof, respectively.

The flip-flop 42 performs sampling of the data signal PS(1, 1), based on the clock signal CK(1, 1) to output a result of the sampling as a data signal PSA, and performs sampling of the data signal PD(1, 1), based on the clock signal CK(1, 1) to output a result of the sampling as a data signal PDA. The flip-flop 42 may be configured of, for example, a D-type flip-flop circuit for sampling of the data signal PS(1, 1) and a D-type flip-flop circuit for sampling of the data signal PD(1, 1).

The control section 41 is a state machine configured to set a state of the pixel P(1, 1), based on the data signals PSA and PDA and the clock signal CK(1, 1) and generate signals LD, PLT, and CKEN. The signal LD and the signal PLT are signals for rewriting of the flag PL included in the data signal PDA. More specifically, the signal LD is a signal that is converted into the flag PL by the rewriting, and the signal PLT is a control signal indicating a timing of the rewriting. Moreover, the signal CKEN is a control signal indicating a timing of storing the luminance data ID in the memory section 46. Further, the control section 41 also has a function of supplying a control signal to the drive section 50.

The selector section 43 is configured to generate a data signal PDB, based on the data signal PDA and the signals LD and PLT. The selector section 43 includes selectors 43A and 43B. A value “0” is input to a first input terminal of the selector 43A, and a value “1” is input to a second input terminal of the selector 43A, and the signal LD is input to a control input terminal of the selector 43A. The selector 43A outputs “0” input to the first input terminal when the signal LD is “0”, and outputs “1” input to the second input terminal when the signal LD is “1”. The data signal PDA is input to a first input terminal of the selector 43B, an output signal from the selector 43A is input to a second input terminal of the selector 43B, and the signal PLT is input to a control input terminal of the selector 43B. The selector 43B outputs the data signal PDA input to the first input terminal when the signal PLT is “0”, and outputs the output signal from the selector 43A input to the second input terminal when the signal PLT is “1”. The selector section 43 is configured to supply the output signal from the selector 43B as the data signal PDB to the flip-flop 44.

By this configuration, the selector section 43 outputs, as the data signal PDB, the data signal PDA without change in a period in which the signal PLT is “0”, and outputs, as the data signal PDB, the signal LD in a period in which the signal PLT is “1”. The signal PLT is a signal that is turned to “1” in a period in which the data signal PDA indicates the flag PL and is turned to “0” in other periods. In other words, the selector section 43 generates the data signal PDB by replacing a portion corresponding to the flag PL of the data signal PDA with the signal LD.

The flip-flop 44 performs sampling of the data signal PSA, based on the clock signal CK(1, 1) to output a result of the sampling as the data signal PS(1, 2), and performs sampling of the data signal PDB, based on the clock signal CK(1, 1) to output a result of the sampling as the data signal PD(1, 2). The flip-flop 44 may be configured of, for example, two D-type flip-flop circuits, as with the flip-flop 42.

The buffer 45 is configured to perform waveform shaping on the clock signal CK(1, 1) to output the waveform-shaped clock signal CK(1, 1) as the clock signal CK(1, 2).

The memory section 46 is configured to hold the luminance data ID. The memory section 46 includes an AND circuit 46A and a shift register 46B. The AND circuit 46A is configured to determine a logical AND between a signal of a first input terminal thereof and a signal of a second input terminal thereof. The signal CKEN supplied from the control section 41 is input to the first input terminal of the AND circuit 46A, and the clock signal CK(1, 1) is input to the second input terminal of the AND circuit 46. In this example, the shift register 46B is a 36-bit shift register. The data signal PDA is input to a data input terminal of the shift register 46B, and an output signal from the AND circuit 46A is input to a clock input terminal of the shift register 46B.

By this configuration, the memory section 46 holds data included in the data signal PDA in a period in which the signal CKEN is “1”. The signal CKEN is a signal that is turned to “1” in a period in which the data signal PDA indicates pixel data ID of 36 bits for the pixel P(1, 1) and is turned to “0” in other periods. Therefore, the AND circuit 46A supplies the clock signal to the shift register 46B in the period in which the data signal PDA indicates the pixel data ID for the pixel P(1, 1). Thus, the shift register 46B holds the pixel data ID of 36 bits for the pixel P(1, 1). At this time, a portion of last 12 bits of the shift register 46B holds the luminance data IDR, a middle portion of 12 bits of the shift register 46B holds the luminance data IDG, and a portion of first 12 bits of the shift register 36B holds the luminance data IDB.

The drive section 50 is configured to drive the light emission section 48, based on the luminance data ID stored in the memory section 46. The drive section 50 includes registers 51R, 51G, and 51B, DACs (D/A converters) 52R, 52G, and 52B, and variable current sources 53R, 53G, and 53B.

The registers 51R, 51G, and 51B are configured to hold data of 12 bits, based on a control signal supplied from the control section 41. More specifically, the register 51R is configured to hold the luminance data IDR stored in the portion of the last 12 bits of the shift register 46B, the register 51G is configured to hold the luminance data IDG stored in the middle portion of 12 bits of the shift register 46B, and the register 51B is configured to hold the luminance data IDB stored in the portion of the first 12 bits of the shift register 46B.

The DACs 52R, 52G, and 52B are configured to convert digital codes of 12 bits stored in the registers 51R, 51G, and 51B into analog voltages, respectively.

The variable current sources 53R, 53G, and 53B are configured to generate drive currents according to the analog voltages supplied from the DACs 52R, 52G, and 52B, respectively.

The light emission section 48 is configured to emit light, based on a drive current supplied from the drive section 50. The light emission section 48 includes light-emitting devices 48R, 48G, and 48B. The light-emitting devices 48R, 48G, and 48B are light-emitting devices each configured with use of an LED, and are configured to emit light of red (R), green (G), and blue (B), respectively.

By this configuration, the DAC 52R generates an analog voltage, based on the luminance data IDR stored in the register 51R. Then, the variable current source 53R generates a drive current, based on the analog voltage to supply the drive current to the light-emitting device 48R of the light emission section 48 through a switch 54R. The light-emitting device 48R emits light with light emission luminance according to the drive current. Likewise, the DAC 52G generates an analog voltage, based on the luminance data IDG stored in the register 51G, the variable current source 53G generates a drive current, based on the analog voltage to supply the drive current to the light-emitting device 48G of the light emission section 48 through a switch 54G, and the light-emitting device 48G emits light with light emission luminance according to the drive current. Moreover, the DAC 52B generates an analog voltage, based on the luminance data IDB stored in the register 51B, the variable current source 53B generates a drive current, based on the analog voltage to supply the drive current to the light-emitting device 48B of the light emission section 48 through a switch 54B, and the light-emitting device 48B emits light with light emission luminance according to the drive current.

It is to be noted that the switches 54R, 54G, and 54B are configured to be subjected to ON/OFF control by a control signal supplied from the control section 41; therefore, in the pixel P, light emission luminance is allowed to be adjusted while maintaining balance of light emission luminance of red (R), green (G), and blue (B).

Blocks configuring each pixel P other than the light emission section 48 are integrated in one chip. In other words, in the display panel 16, (M×N) number of chips and (M×N) number of light emission sections 48 are arranged in a matrix form.

The pixel P corresponds to a specific example of “unit pixel” in an embodiment of the present disclosure. The clock signals CK(1, 1) to CK(M, 1) correspond to a specific example of “a plurality of clock signals” in an embodiment of the present disclosure. The clock generation section 22 corresponds to a specific example of “multiphase clock generation section” in an embodiment of the present disclosure. The clock signals CKA to CKD correspond to a specific example of “reference clock signals” in an embodiment of the present disclosure. The pixels P(1, 1) to P(M, 1) correspond to specific examples of “first unit pixel” in an embodiment of the present disclosure. A group configured of the pixels P(1, 1) to P(1, N) corresponds to a specific example of “unit pixel group” in an embodiment of the present disclosure.

### Operation and Functions

Next, an operation and functions of the display unit 1 according to this embodiment will be described below.

### Outline of Entire Operation

First, an outline of an entire operation of the display unit 1 will be described below referring to FIG. 1 and the like. The RF section 11 performs processing such as down-converting on a broadcast wave (an RF signal) received by the antenna 19. The demodulation section 12 performs demodulation processing on a signal supplied from the RF section 11. The demultiplexer section 13 separates, into a video signal and an audio signal, a signal (stream) that is supplied from the demodulation section 12 and is obtained by multiplexing the video signal and the audio signal. The decoder section 14 decodes a signal (the video signal and the audio signal) supplied from the demultiplexer section 13. The signal conversion section 15 performs format conversion of the signal, and outputs the format-converted signal as the image signal Sdisp.

In the display panel 16, the display drive section 20 drives the display section 30, based on the image signal Sdisp supplied from the signal conversion section 15. More specifically, the display drive section 20 supplies the signal S(1, 1) to S(M, 1) to respective pixel columns of the pixels P in the display section 30. Each pixel P receives the signal S (the data signals PS and PD and the clock signal CK) from the pixel P previous thereto, and supplies the signal S to the pixel P subsequent thereto. Then, each pixel P reads the luminance data ID for that pixel P from the data signal PD, and emits light with light emission luminance according to the luminance data ID.

### Specific Operation of Pixel P

In the pixel P, the control section 41 functions as a state machine, and controls the operation of the pixel P. First, an operation of the control section 41 will be described in detail below.

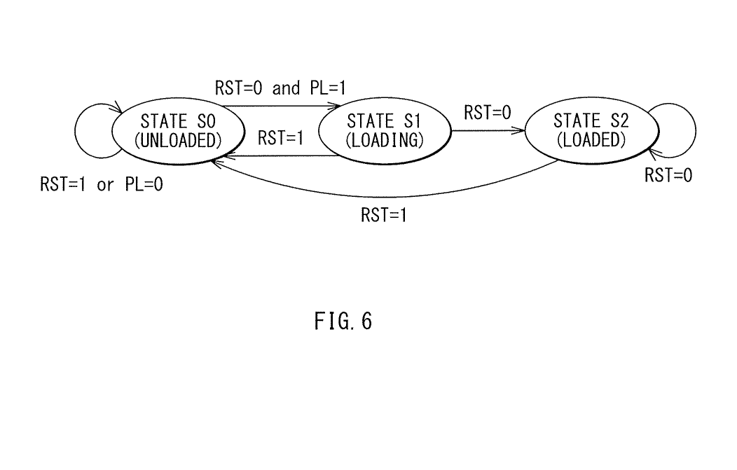

FIG. 6 illustrates a state transition diagram of the control section 41. As illustrated in FIG. 6, the pixel P has three states S0 to S2.

The state S0 indicates a state (Unloaded) in which the pixel P does not read the luminance data ID. In the state S0, the control section 41 sets the signal LD to “0”. Therefore, the pixel P replaces the flag PL of the input signal PD with “0”. Moreover, the control section 41 sets the signal CKEN to “0”.

The state S1 indicates a state (Loading) in which the pixel P is reading the luminance data ID. In this state S1, the control section 41 sets the signal LD to “0”. Therefore, the pixel P replaces the flag PL of the input signal PD with “0”. Moreover, the control section 41 sets the signal CKEN to “1” in a period in which the signal PDA indicates the luminance data ID, and sets the signal CKEN to “0” in other periods. Therefore, the luminance data ID is stored in the memory section 46.

The state S2 indicates a state (Loaded) in which the pixel P has read the luminance data ID. In the state S2, the control section 41 sets the signal LD to “1”. Therefore, the pixel P replaces the flag PL of the input signal PD with “1”. Moreover, the control section 41 sets the signal CKEN to “0”.

Transition of these three states S0 to S2 is performed, based on the flags RST and PL included in the data signal PDA (the data signal PD). First, when “1” is input as the flag RST, the control section 41 sets the pixel P to the state S0 (Unloaded). In a case where “1” is input as the flag RST (RST=1) in the state S0 (Unloaded), or in a case where “0” is input as the flag PL (P=0) in the state S0 (Unloaded), the state of the pixel P is maintained in the state S0 (Unloaded).

In a case where “0” is input as the flag RST and “1” is input as the flag PL (RST=0 and PL=1) in the state S0 (Unloaded), the state of the pixel P is transitioned from the state S0 (Unloaded) to the state S1 (Loading). In a case where “1” is input as the flag RST (RST=1) in the state S1 (Loading), the state of the pixel P is transitioned from the state Si (Loading) to the state S0 (Unloaded).

Moreover, in a case where “0” is input as the flag RST in the state S1 (Loading), the state of the pixel P is transitioned from the state S1 (Loading) to the state S2 (Loaded). In a case where “0” is input as the flag RST (RST=0) in the state S2 (Loaded), the state of the pixel P is maintained in the state S2 (Loaded). Then, in a case where “1” is input as the flag RST (RST=1) in the state S2 (Loaded), the state of the pixel P is transitioned from the state S2 (Loaded) to the state S0 (Unloaded).

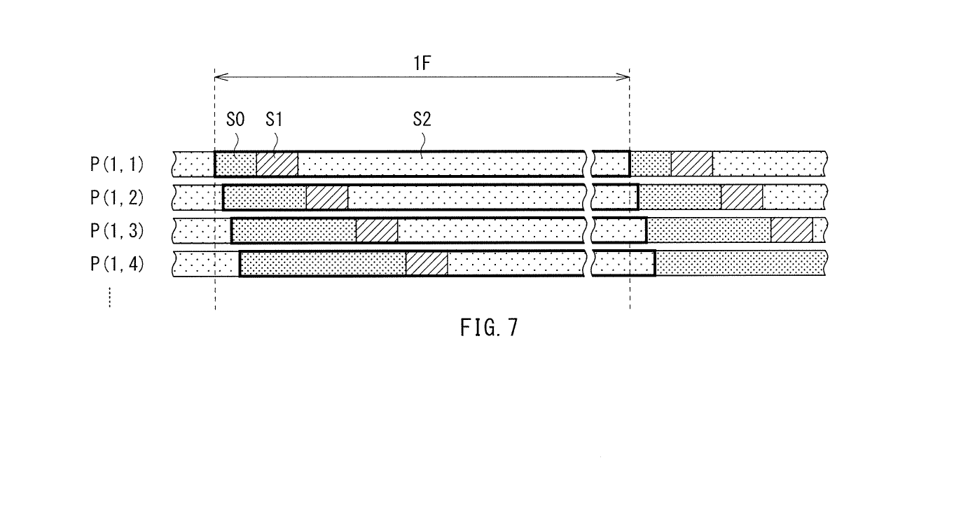

FIG. 7 illustrates states of the pixels P(1, 1) to P(1, N) of the leftmost pixel column in one frame period (1 F). It is to be noted that the pixels P of other pixel columns are similar to the pixels P of the leftmost pixel column. When the one frame period (1 F) starts, “1” is input to the pixel P(1, 1) in the first stage as the flag RST, and the state of the pixel P(1, 1) is set to the state S0 (Unloaded). After that, the pixels P(1, 1) to P(1, N) are sequentially set to the state S0 (Unloaded) in the one frame period (1 F). At this time, start timings of periods of the states S0 (Unloaded) in adjacent pixels P are different from each other by delay in the flip-flops 42 and 44 (2 pulses of the clock signal CK). Next, the states of the pixels P(1, 1) to P(1, N) are sequentially transitioned from the state S0 (Unloaded) to the state S1 (Loading). In the state S1 (Loading), the pixels P(1, 1) to P(1, N) sequentially read the luminance data ID. After that, the states of the pixels P(1, 1) to P(1, N) are sequentially transitioned from the state S1 (Loading) to the state S2 (Loaded). In the state S2 (Loaded), the pixels P(1, 1) to P(1, N) emit light with light emission luminance according to the read luminance data ID.

In the display unit 1, the pixels P are connected in a daisy chain fashion. Therefore, each pixel P receives the data signals PS and PD and the clock signal CK from the pixel P previous thereto, and supplies these signals to the pixel P subsequent thereto. Then, each pixel P reads the luminance data ID for that pixel P, and emits light with light emission luminance according to the luminance data ID. In the display unit 1, the pixels P are connected in a daisy chain fashion in such a manner; therefore, image quality is allowed to be enhanced.

In other words, for example, in a display unit described in Japanese Unexamined Patent Application Publication No. 2012-32828, a drive section drives each pixel through a gate line or a data line. The gate line or the data line is so-called global wiring connected to a plurality of pixels belonging to one pixel column or a plurality of pixels belonging to one pixel row. Therefore, for example, to achieve a large-screen display unit, lengths of these wiring lines are increased; therefore, resistance or parasitic capacity of the wiring lines may be increased, and each pixel may not be allowed to be sufficiently driven accordingly. Moreover, for example, to achieve a high-definition display unit, it is necessary to drive a larger number of lines in each frame period; therefore, time assigned to one horizontal period (1 H) may be reduced, and each pixel may not be allowed to be sufficiently driven accordingly. Further, for example, to increase a frame rate, time assigned to one horizontal period (1 H) may be reduced, and each pixel may not be allowed to be sufficiently driven accordingly.

On the other hand, in the display unit 1 according to this embodiment, the pixels are connected in a daisy chain fashion. In other words, each pixel P drives the pixel P subsequent thereto not through the above-described global wiring but through local wiring between the pixels. Therefore, each pixel P is allowed to drive the pixel P subsequent thereto relatively easily through such short wiring, and a large-screen display unit is allowed to be achieved. Moreover, since the wiring is short, each pixel P is allowed to increase transfer speed of the data signals PS, PD, and the like relatively easily, and a high-definition display unit or a display unit with a high frame rate is allowed to be achieved.

Moreover, since the pixels P are connected in a daisy chain fashion in such a manner, the configuration of the display unit 1 is allowed to be simplified. In other words, in the display unit described in Japanese Unexamined Patent Application Publication No. 2012-32828, a plurality of gate lines extending along a horizontal direction, a plurality of data lines extending along a vertical direction, a so-called gate driver connected to the gate lines, and a so-called data driver connected to the data lines are provided; therefore, the configuration of the display unit may be complicated. On the other hand, in the display unit 1 according to this embodiment, the pixels P are connected in a daisy chain fashion; therefore, as illustrated in FIG. 2, it is only necessary to provide wiring between the pixels P extending along the vertical direction and the display drive section 20. Therefore, it is not necessary to provide wiring extending along the horizontal direction and a drive section for driving of the wiring, and the configuration of the display unit 1 is allowed to be simplified.

Moreover, in the display unit 1, light emission of each pixel P is controlled with use of a digital signal (the data signals PS and PD and the clock signal CK); therefore, an influence of noise on image quality is allowed to be reduced. For example, in the display unit in Japanese Unexamined Patent Application Publication No. 2012-32828, an analog signal is used; therefore, noise may cause deterioration in image quality. Moreover, specifically in the large-screen display unit, the high-definition display unit, and the display unit with a high frame rate, the influence of noise on image quality may be further increased. On the other hand, in the display unit 1 according to this embodiment, the digital signal is used; therefore, the influence of noise on image quality is allowed to be reduced.

Further, since the digital signals are used in such a manner, radiation is allowed to be reduced. In other words, for example, in a case where an analog signal is used, in terms of gradation expression, resistance to noise, and the like, signal amplitude may be increased, and in this case, radiation may be increased. On the other hand, in the display unit 1 according to this embodiment, the digital signal is used; therefore, the signal amplitude is allowed to be reduced, thereby reducing radiation.

Furthermore, in the display unit 1, each pixel P includes the flip-flops 42 and 44 and the buffer 45; therefore, signal amplitudes of the data signals PS and PD and the like are allowed to be reduced. In other words, in a case where the flip-flops 42 and 44 and the buffer 45 are not provided, the signal amplitude may be attenuated with an increasing distance from the display drive section. In this case, it is necessary for the display drive section to generate the data signals PS and PD with a large signal amplitude. On the other hand, in the display unit 1, the signal amplitude is maintained by performing waveform shaping on the data signals PS and PD and the clock signal CK every time these signals pass through the pixel P. In other words, a possibility that the signal amplitude is attenuated is allowed to be reduced; therefore, the signal amplitudes of the data signals PS and PD are allowed to be reduced. Therefore, while the above-described radiation is allowed to be reduced, a power supply voltage is allowed to be reduced, and power consumption is allowed to be reduced.

Moreover, in the display unit 1, since the memory section 46 is provided to each pixel P, for example, in a case where a still image is displayed, it is not necessary to perform data transfer, and power consumption is allowed to be reduced accordingly.

Further, in the display unit 1, since the flip-flops 42 and 44 that perform sampling of the data signal PS and PD, based on the clock signal CK are provided to each pixel, a relative phase relationship between the data signals PS and PD and the clock signal CK is allowed to be maintained.

### About Transition Timing of Data Signals PS and PD

In the display unit 1, the display drive section 20 supplies the signal S(1, 1) to S(M, 1) to respective pixel columns of the pixels P in the display section 30. At this time, in the display drive section 20, the output circuits 23(1) to 23(M) operate, based on the clock signals CKA to CKD of four phases. Therefore, in the display unit 1, a possibility that each pixel P malfunctions is allowed to be reduced, deterioration in image quality is allowed to be reduced accordingly. Specific description about this will be given below.

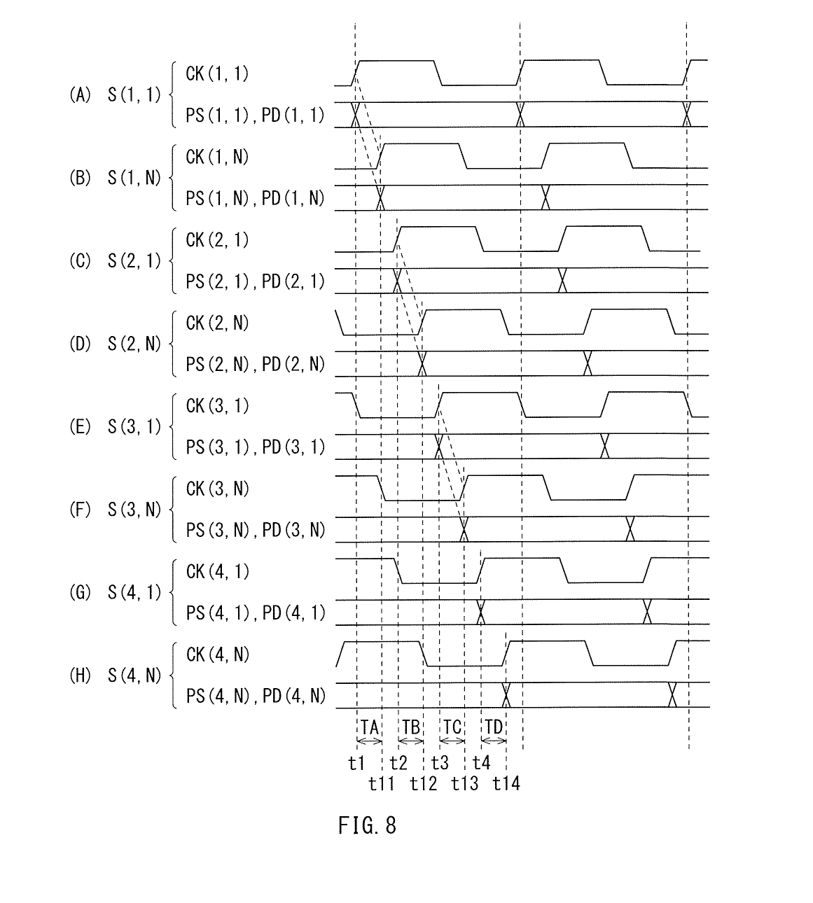

FIG. 8 illustrates a timing diagram of an operation of each pixel P of the display section 30, where a part (A) indicates a waveform of the signal S(1, 1), a part (B) indicates a waveform of the signal S(1, N), a part (C) indicates a waveform of a signal S(2, 1), a part (D) indicates a waveform of a signal S(2, N), a part (E) indicates a waveform of a signal S(3, 1), a part (F) indicates a waveform of a signal S(3, N), a part (G) indicates a waveform of a signal S(4, 1), and a part (H) indicates a waveform of a signal S(4, N). It is to be noted that, in this example, the signals S(1, 1) to S(4, N) for four pixel columns from the left of the display section 30 are illustrated; however, other signals S(5, 1) to S(M, N) are similar to the signals S(1, 1) to S(4, N).

In each pixel column in the display section 30, the pixels P are connected in a daisy chain fashion; therefore, the clock signal CK input to each pixel P is delayed by the buffer 45 in the pixel P every time the clock signal CK passes through the pixel P, and the data signals PS and PD are also delayed accordingly. In other words, the signal S is delayed by the buffer 45 every time the signal S passes through the pixel P. Therefore, for example, in the leftmost pixel column, as illustrated in the part (A) in FIG. 8, when the input signal S(1, 1) of the first pixel P(1, 1) is transitioned at a timing t1, respective pixels P of the pixel column gradually delay the signal S, and the input signal S(1, N) of the pixel P(1, N) in the last stage is transitioned at a timing t11, as illustrated in the part (B) in FIG. 8. In other words, transition timings of the signals S(1, 1) to S(1, N) are distributed in a period TA from the timing t1 to the timing t11. Likewise, in a second pixel column from the left, when the input signal S(2, 1) of the pixel P(2, 1) in a first stage is transitioned at a timing t2, an input signal S(2, N) of the pixel P(2, N) in a last stage is transitioned at a timing t12 (refer to the parts (C) and (D) in FIG. 8), and transition timings of the signals S(2, 1) to S(2, N) are distributed in a period TB from the timing t2 to the timing t12. Likewise, in a third pixel column from the left, when an input signal S(3, 1) of the pixel P(3, 1) in a first stage is transitioned at a timing t3, an input signal S(3, N) of the pixel P(3, N) in a last stage is transitioned at a timing t13 (refer to the parts (E) and (F) in FIG. 8), and transition timings of the signals S(3, 1) to S(3, N) are distributed in a period TC from the timing t3 to the timing t13. Then, in a fourth pixel column from the left, when an input signal S(4, 1) of the pixel P(4, 1) in a first stage is transitioned at a timing t4, an input signal S(4, N) of the pixel P(4, N) in a last stage is transitioned at a timing t14 (refer to the parts (G) and (H) in FIG. 8), and transition timings of the signals S(4, 1) to S(4, N) are distributed in a period TD from the timing t4 to the timing t14.

Thus, in the display unit 1, the display drive section 20 generates the signals S(1, 1) to S(M, 1), based on the clock signals CKA to CKD of four phases, respective pixel columns of the pixels Pin the display section 30 operate, based on the signals S(1, 1) to S(M, 1); therefore, transition timings of respective signals S are provided so as to be distributed in four periods TA to PD; therefore, fluctuation of a power supply voltage level or a ground level of the pixel P is allowed to be reduced. In other words, for example, if the display drive section 20 generates signals S(1, 1) to S(M, 1), based on not the clock signals CKA to CKD of four phases but a single clock signal, the transition timings of the respective signals S are provided so as to be distributed only in, for example, one period TA, and fluctuation of the power supply voltage level or the ground level of the pixel P may be increased. Thus, in a case where fluctuation of the power supply level or the ground level is large, the pixel P may malfunction to cause deterioration in image quality of the display unit 1. On the other hand, in the display unit 1, the display drive section 20 generates the signals S(1, 1) to S(M, 1), based on the clock signals CKA to CKD of four phases; therefore, as illustrated in FIG. 8, the transition timings of the respective signals S are provided so as to be distributed in four periods TA to PD; therefore, fluctuation of the power supply voltage level or the ground level of the pixel P is allowed to be reduced. Therefore, a possibility that the pixel P malfunctions is allowed to be reduced, and a possibility that image quality of the display unit 1 is deteriorated is allowed to be reduced. Moreover, fluctuation of the power supply level or the ground level of the pixel P is allowed to be reduced; therefore, decoupling capacitors between a power supply and a ground may be reduced to an extent that the pixel P does not malfunction. In this case, components in the display section 30 are allowed to be reduced, and design flexibility such as layout of components in the display section 30 is allowed to be enhanced.

### Effects

As described above, in this embodiment, the display drive section generates a signal, based on the clock signals of four phases; therefore, a possibility that the pixel malfunctions is allowed to be reduced, a possibility that image quality of the display unit is deteriorated is allowed to be reduced, and design flexibility such as layout of components is allowed to be enhanced.

### Modification Example 1-1

In the above-described embodiment, although the clock generation section 22 generates the clock signals CKA to CKD of four phases, the number of phases is not limited thereto. Alternatively, clock signals of two phases, three phases, or five or more phases may be generated. A display unit 1A including a display drive section 20A that generates clock signals CKA and CKC of two phases will be described in detail below.

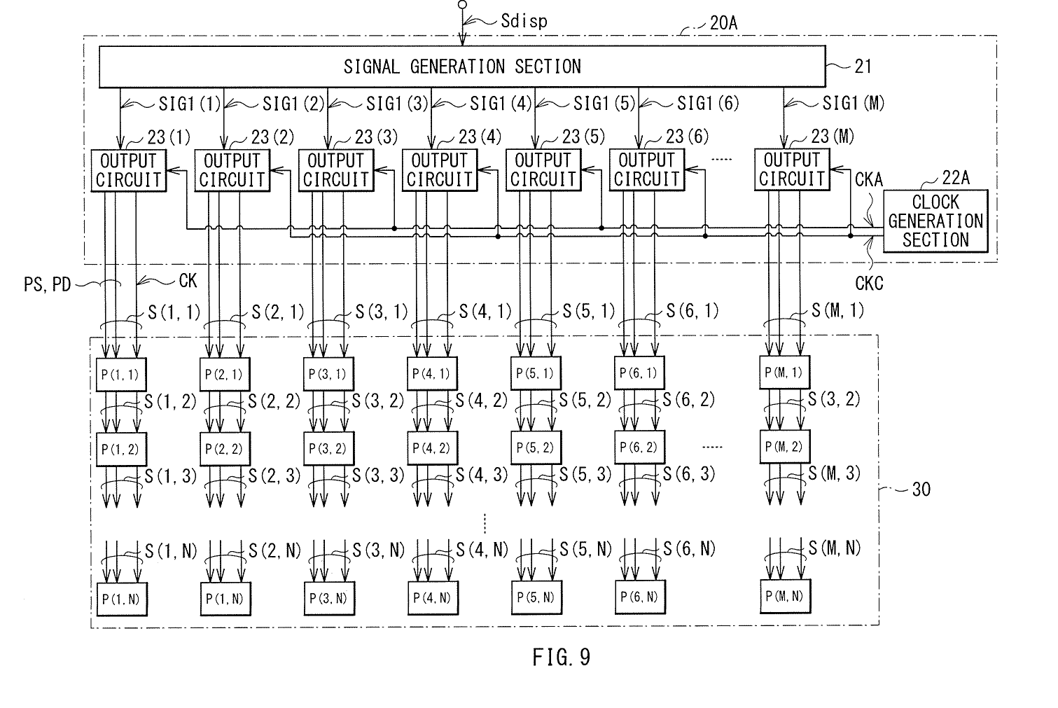

FIG. 9 illustrates a configuration example of the display drive section 20A. The display drive section 20A includes a clock generation section 22A. The clock generation section 22A is configured to generate the clock signals CKA and CKC of two phases. The clock signals CKA and CKC are about 180° out of phase with each other. Then, the clock generation section 22A supplies one of the clock signals CKA and CKC to each of the output circuits 23(1) to 23(M). More specifically, in this example, the clock generation section 22A supplies the clock signal CKA to odd-numberth output circuits 23(1), 23(3), 23(5), and so on, and supplies the clock signal CKC to even-numberth output circuits 23(2), 23(4), 23(6), and so on.

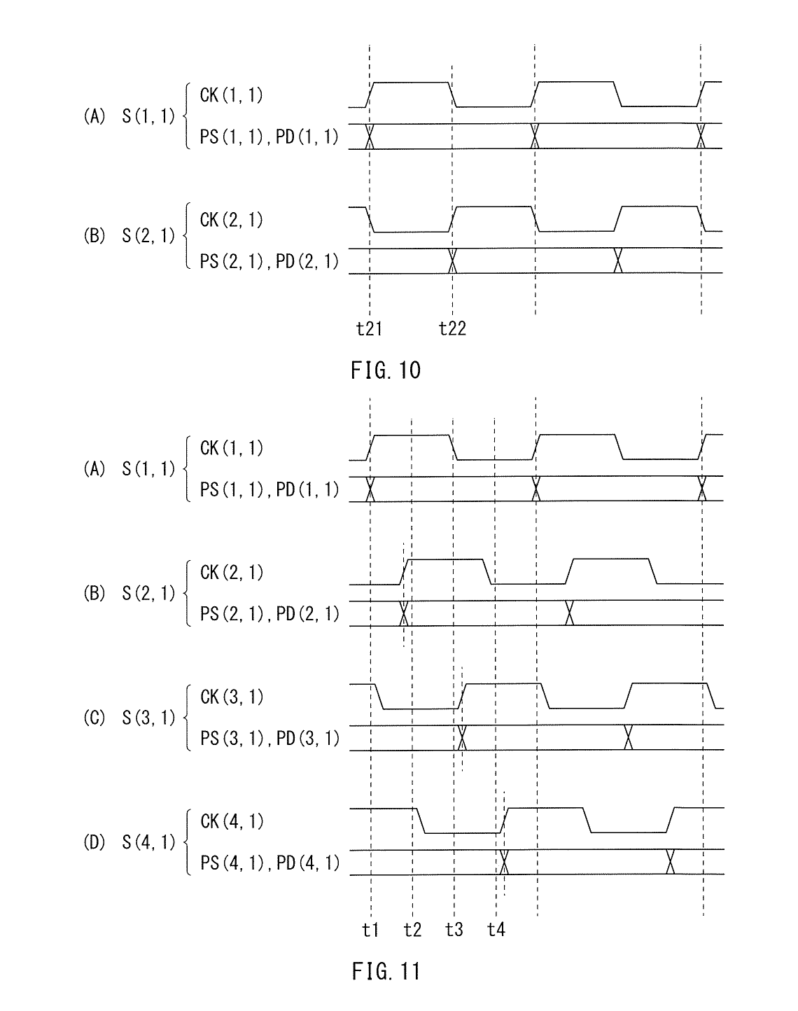

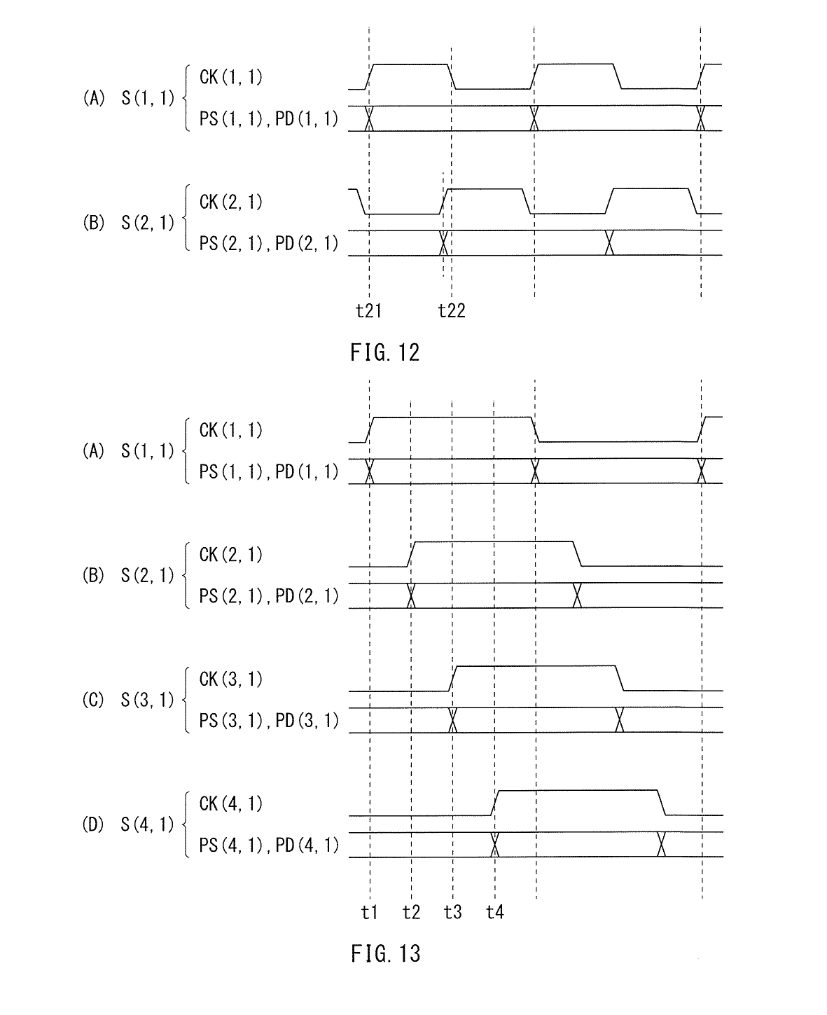

FIG. 10 illustrates a timing diagram of output signals from the output circuits 23(1) and 23(2), where a part (A) indicates a waveform of the output signal S(1, 1) from the output circuit 23(1), and a part (B) indicates a waveform of an output signal S(2, 1) from the output circuit 23(2). Even in this case, the output circuits 23(1) and 23(2) operate, based on the clock signals CKA and CKC of two phases; therefore, a transition timing t21 (refer to the part (A) in FIG. 10) of the data signals PS(1, 1) and PD(1, 1) and a transition timing t22 (refer to the part (B) in FIG. 10) of the data signals PS(2, 1) and PD(2, 1) are allowed to be different from each other. Thus, in the display unit 1A, as with the display unit 1, a possibility that each pixel P malfunctions is allowed to be reduced, and deterioration in image quality is allowed to be reduced.

### Modification Example 1-2

In the above-described embodiment, a phase difference between adjacent clock signals of the clock signals CKA to CKD (the clock signals CK(1, 1) to CK(4, 1)) is about 90°; however, the phase difference is not limited thereto. For example, as illustrated in FIG. 11, the phase difference may be other than about 90°. Likewise, for example, in the display unit 1A according to Modification Example 1-1, a phase difference between the clock signals CKA and CKC (the clock signals CK(1, 1) and CK(2, 1)) is about 180°; however, the phase difference is not limited thereto, and may be other than about 180°.

### Modification Example 1-3

In the above-described embodiment, a cycle of the clock signal CK is equal to a pulse width of one bit in the data signals PS and PD; however, the cycle of the clock signal CK is not limited thereto. Alternatively, as illustrated in FIG. 13, for example, the cycle of the clock signal CK may be equal to a pulse width of two bits in the data signals PS and PD. In this case, for example, the flip-flops 42 and 44 of each pixel P are allowed to use a circuit that operates at both a rising edge and a trailing edge.

### Modification Example 1-4

In the above-described embodiment, the clock signal CK is supplied to each pixel P; however, a signal supplied to each pixel P is not limited thereto. Alternatively, for example, a differential clock signal may be supplied to each pixel. A display unit 1B according to this modification example will be described in detail below.

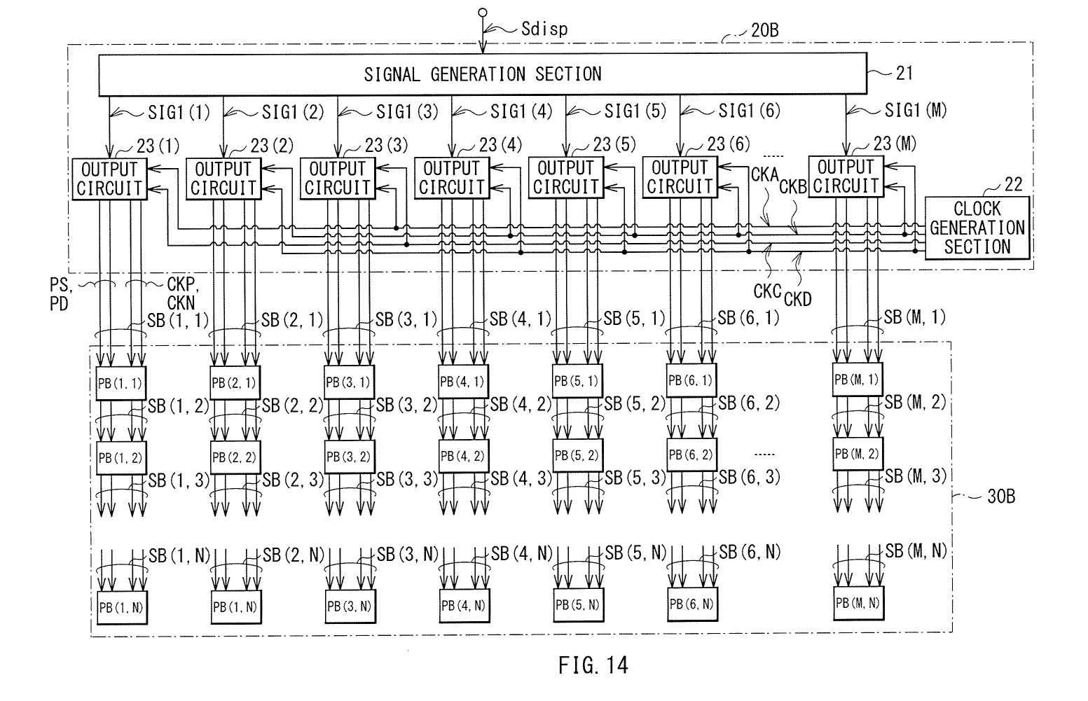

FIG. 14 illustrates a configuration example of a display drive section 20B and a display section 30B in the display unit 1B. The display drive section 20B includes a plurality of output circuits 23B(1) to 23B(M). The output circuits 23B(1) to 23B(M) are configured to generate signals SB(1, 1) to SB(M, 1), based on signals SIG1(1) to SIG1(M) and the clock signals CKA to CKD.

The clock generation section 22 supplies to the clock signal CKA and CKC or the clock signals CKB and CKD to each of the output circuits 23B(1) to 23B(M). More specifically, in this example, the clock generation section 22 supplies a differential clock signal CKAC configured of the clock signals CKA and CKC to the output circuits 23B(1), 23B(5), 23B(9), and so on, and supplies a differential clock signal CKBD configured of the clock signals CKB and CKD to the output circuits 23B(2), 23B(6), 23B(10), and so on. The clock generation section 22 supplies, to the output circuits 23B(3), 23B(7), 23B(11), and so on, a differential clock signal CKCA configured of the clock signals CKC and CKA, i.e., a signal that is about 180° out of phase with the differential clock signal CKAC, and supplies, to the output circuits 23B(4), 23B(8), 23B(12), and so on, a differential clock signal CKDB configured of the clock signals CKD and CKB, i.e., a signal that is about 180° out of phase with the differential clock signal CKBD.

Thus, for example, the output circuit 23B(1) generates and outputs data signals PS(1, 1) and PD(1, 1) in synchronization with the differential clock signal CKAC (the clock signals CKA and CKC), based on the signal SIG1(1) and the differential clock signal CKAC, and outputs the clock signals CKA and CKC as clock signals CKP(1, 1) and CKN(1, 1), respectively, to supply these signals as a signal SB(1, 1) to the display section 30B. Moreover, for example, the output circuit 23B(2) generates and outputs the data signals PS(2, 1) and PD(2, 1) in synchronization with the differential clock signal CKBD (the clock signals CKB and CKD), based on the signal SIG1(2) and the differential clock signal CKBD, and outputs the clock signals CKB and CKD as clock signals CKP(2, 1) and CKN(2, 1), respectively, to supply these signals as a signal SB(2, 1) to the display section 30B. Further, for example, the output circuit 23B(3) generates and outputs the data signals PS(3, 1) and PD(3, 1) in synchronization with the differential clock signal CKCA (the clock signals CKC and CKA), based on the signal SIG1(3) and the differential clock signal CKCA, and outputs the clock signals CKC and CKA as clock signals CKP(3, 1) and CKN(3, 1), respectively, to supply these signals as a signal SB(3, 1) to the display section 30B. Furthermore, for example, the output circuit 23B(4) generates and outputs the data signals PS(4, 1) and PD(4, 1) in synchronization with the differential clock signal CKDB (the clock signals CKD and CKB), based on the signal SIG1(4) and the differential clock signal CKDB, and outputs the clock signals CKD and CKB as clock signals CKP(4, 1) and CKN(4, 1), respectively, to supply these signals as a signal SB(4, 1) to the display section 30B.

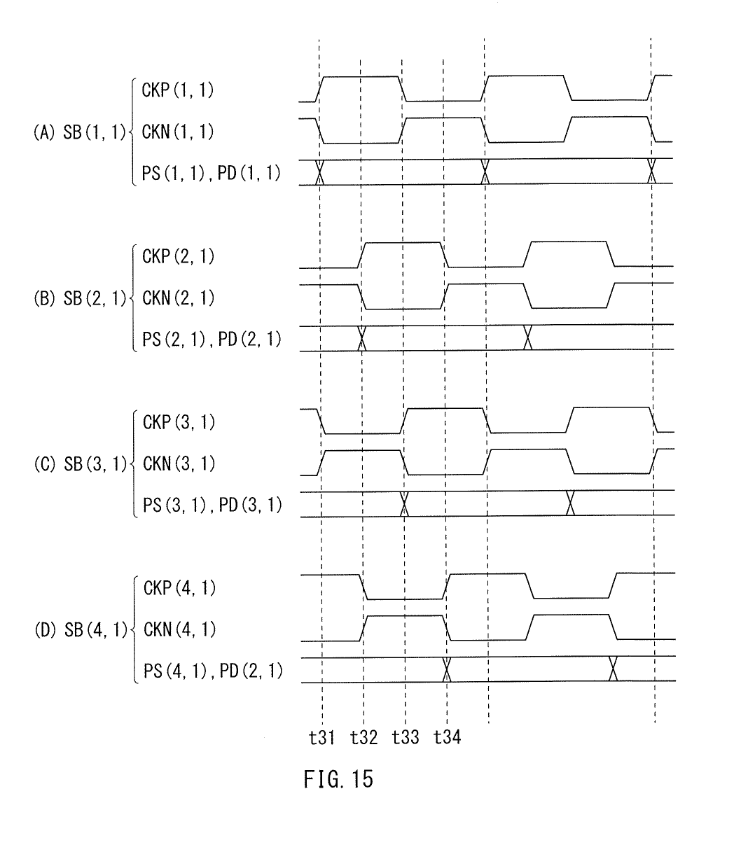

FIG. 15 illustrates a timing diagram of output signals from the output circuits 23B(1) to 23B(4), where a part (A) indicates a waveform of the output signal SB(1, 1) from the output circuit 23B(1), a part (B) indicates a waveform of the output signal SB(2, 1) from the output circuit 23B(2), a part (C) indicates a waveform of the output signal SB(3, 1) from the output circuit 23B(3), and a part (D) indicates a waveform of the output signal SB(4, 1) from the output circuit 23B(4). Even in this case, the output circuits 23B(1) to 23B(4) operate, based on differential signals of four phases configured of the clock signals CKA to CKD of four phases; therefore, transition timings of the data signals PS and PD are allowed to be different from each other.

The display section 30B is configured to display an image, based on driving by the display drive section 20B. The display section 30B includes a plurality of pixels PB arranged in a matrix form.

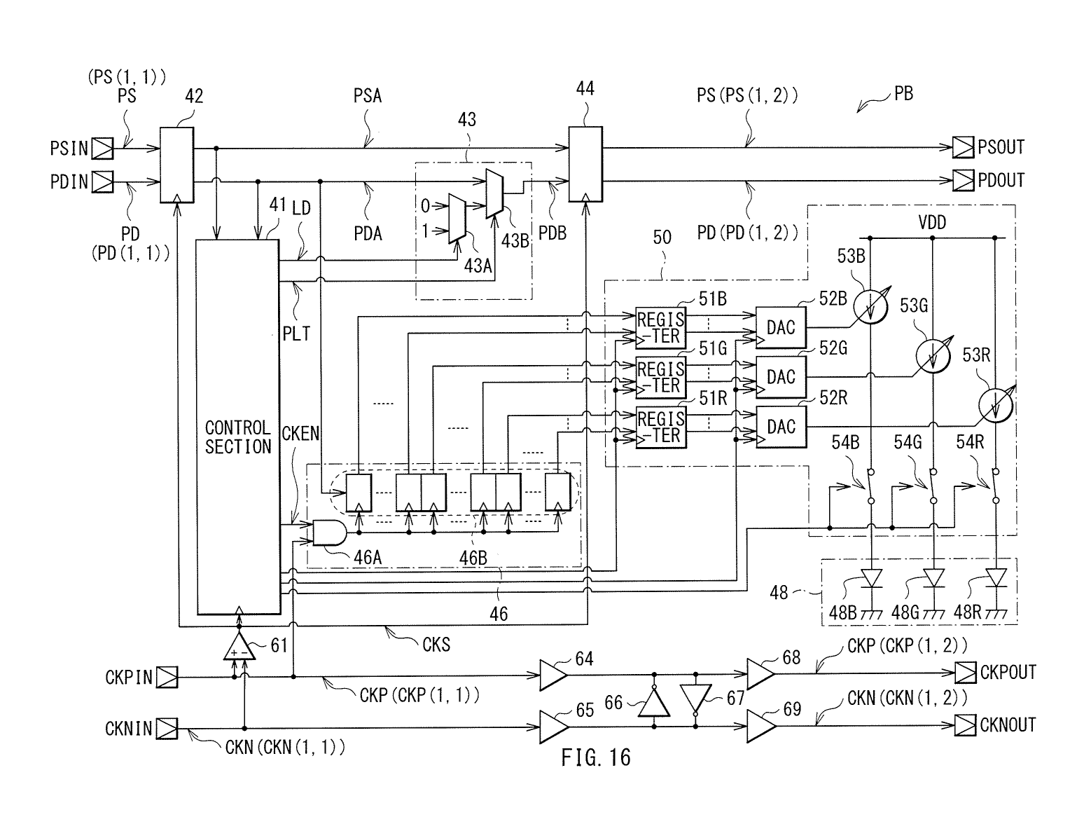

FIG. 16 illustrates a configuration example of the pixel PB. The pixel PB includes buffers 61, 64, 65, 68, and 69, and inverters 66 and 67. It is to be noted that, for convenience of description, a pixel PB(1, 1) will be described as an example; however, other pixels PB are similar to the pixel PB(1, 1).

The pixel PB(1, 1) generates data signals PS(1, 2) and PD(1, 2) and clock signals CKP(1, 2) and CKN(1, 2), based on the data signals PS(1, 1) and PD(1, 1), the clock signal CKP(1, 1) input to an input terminal CKPIN thereof, and the clock signal CKN(1, 1) input to an input terminal CKNIN thereof. Then, the pixel PB(1, 1) outputs the data signal PS(1, 2), the data signal PD(1, 2), the clock signal CKP(1, 2), and the clock signal CKN(1, 2) from an output terminal PSOUT, an output terminal PDOUT, an output terminal CKPOUT, and an output terminal CKNOUT thereof, respectively.

The buffer 61 is a circuit configured to convert a differential signal into a single-ended signal. More specifically, the buffer 61 converts a differential signal configured of clock signals CKP(1, 1) and CKN(1, 1) into a clock signal CKS that is a single-ended signal. The control section 41, the flip-flops 42 and 44, and the memory section 46 operate, based on the clock signal CKS.

The buffers 64 and 65 are configured to perform waveform shaping on an input signal to output the waveform-shaped signal. More specifically, the buffer 64 performs waveform shaping on the clock signal CKP(1, 1), and the buffer 65 performs waveform shaping on the clock signal CKN(1, 1).

The inverters 66 and 67 are inverting circuits configured to invert an input signal to output the inverted signal. An input terminal of the inverter 66 is connected to an output terminal of the inverter 67 and an output terminal of the buffer 65, and an output terminal of the inverter 66 is connected to an input terminal of the inverter 67 and an output terminal of the buffer 64. Moreover, the input terminal of the inverter 67 is connected to the output terminal of the inverter 66 and the output terminal of the buffer 64, and the output terminal of the inverter 67 is connected to the input terminal of the inverter 66 and the output terminal of the buffer 65. By this configuration, the inverters 66 and 67 configure a latch circuit.

The buffer 68 is configured to perform waveform shaping on an output signal from the buffer 64 to output the waveform-shaped signal as a clock signal CKP(1, 2). The buffer 69 is configured to perform waveform shaping on an output signal from the buffer 65 to output the waveform-shaped signal as a clock signal CKN(1, 2).

As described above, the differential clock signals CKP and CKN are used; therefore, a possibility that a waveform of a clock signal is deteriorated by transmission is allowed to be reduced. In other words, in a case where a single-ended clock signal CK is used as with the above-described embodiment, for example, a duty ratio of the clock signal CK may be changed after the clock signal CK passes through a plurality of buffers 45. Such a phenomenon may occur, for example, in a case where characteristics of a transistor configuring the buffer 45 are varied. In a case where the duty ratio is changed in such a manner, for example, clock transmission may not be allowed to be performed properly, or a sampling timing in the flip-flop 42 of the pixel P may be shifted, and the pixel P may not operate properly. On the other hand, in the pixel PB according to the modification example, when the inverters 66 and 67 perform a latch operation, a change in the duty ratio is allowed to be reduced.

### Modification Example 1-5

In the above-described embodiment, the drive section 50 is configured with use of the DACs 52R, 52G, and 52B; however, the drive section is not limited thereto. Alternatively, for example, a drive section may be configured with use of a counter. A pixel PC according to this modification example will be described in detail below.

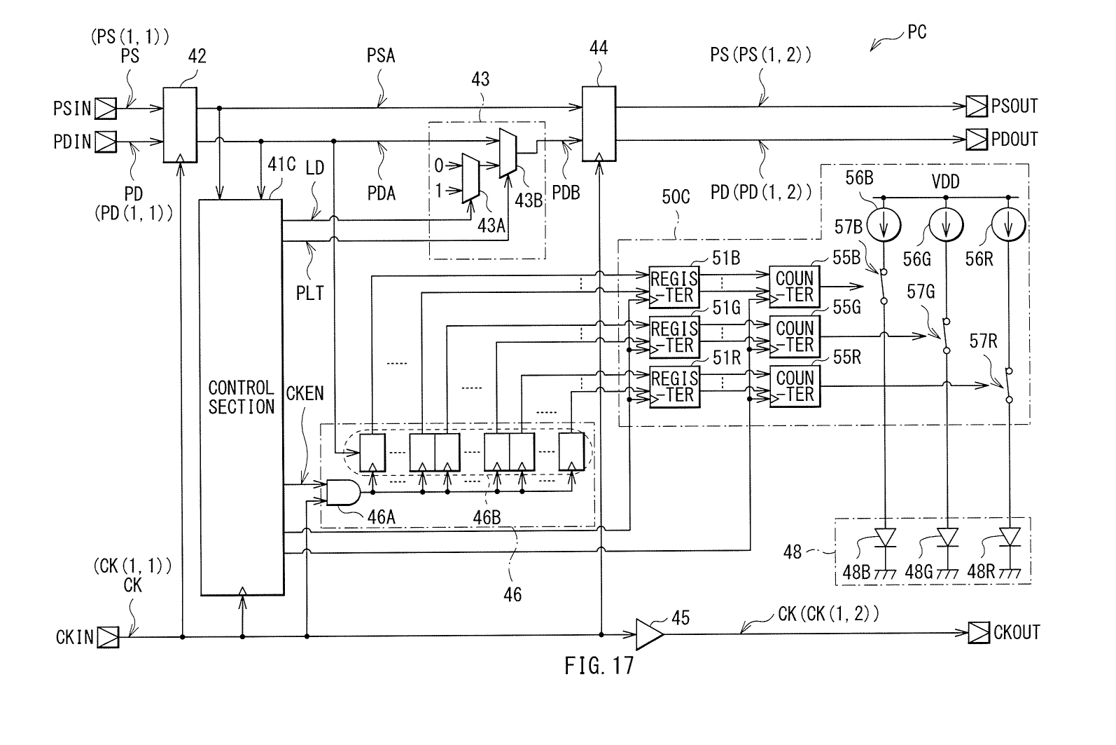

FIG. 17 illustrates a configuration example of the pixel PC. The pixel PC includes a control section 41C and a drive section 50C. The control section 41C has a function similar to that of the control section 41 according to the above-described embodiment, and the control section 41C is configured to function as a state machine and to supply a control signal to the drive section 50C.

The drive section 50C includes counters 55R, 55G, and 55B, current sources 56R, 56G, and 56B, and switches 57R, 57G, and 57B. The counters 55R, 55G, and 55B are counters configured to generate pulse signals with pulse widths according to the luminance data IDR, IDG, and IDB stored in the registers 51R, 51G, and 51B by counting clock pulses of a control signal (a clock signal for counter) supplied from the control section 41C with use of the control signal as a reference. Each of the current sources 56R, 56G, and 56B is configured to generate a certain drive current. The switches 57R, 57G, and 57B are configured to be turned on or off in response to pulse signals supplied from the counters 55R, 55G, and 55B.

By this configuration, for example, the counter 55R generates a pulse signal with a pulse width according to the luminance data IDR stored in the register 51R. Then, the switch 57R is turned on or off in response to the pulse signal to supply a drive current generated by the current source 56R to the light-emitting device 48R.

Therefore, the pixel PC is allowed to change light emission luminance by changing light emission time. In other words, while the pixel P according to the above-described embodiment changes light emission luminance (luminance×time) by changing luminance I, the pixel PC according to this modification example is allowed to change light emission luminance (luminance×time) by changing a duration in which light is emitted.

### 2. Second Embodiment

Next, a display unit 2 according to a second embodiment will be described below. The display unit 2 according to this embodiment is configured so as to allow a delay amount in each pixel to be adjusted. It is to be noted that like components are denoted by like numerals as of the display unit 1 according to the above-described first embodiment and will not be further described.

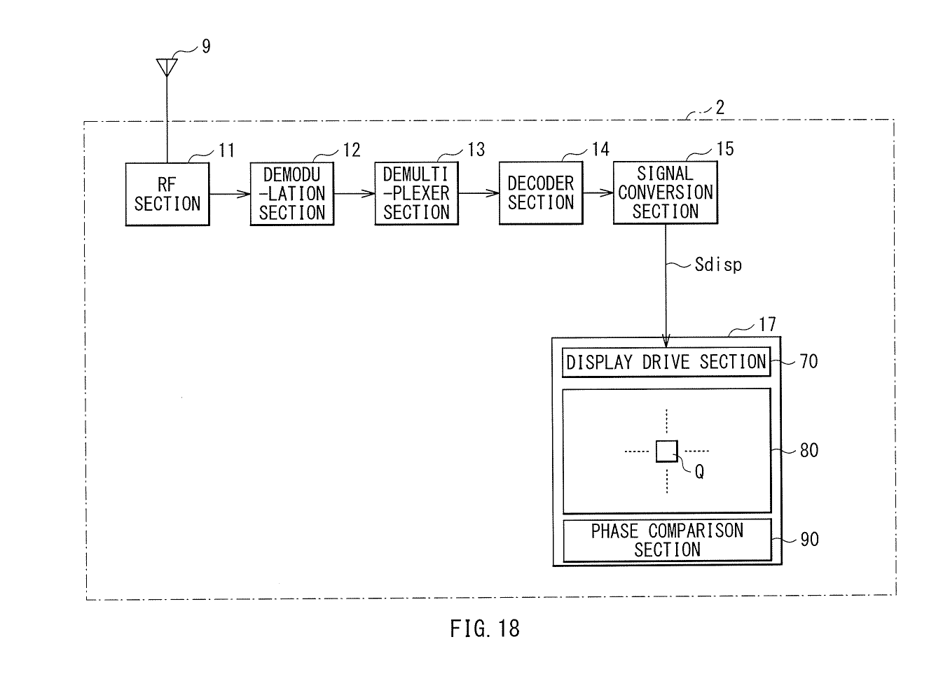

FIG. 18 illustrates a configuration example of the display unit 2. The display unit 2 includes a display panel 17. The display panel 17 includes a display drive section 70, a display section 80 including a plurality of pixels Q arranged in a matrix form, and a phase comparison section 90.

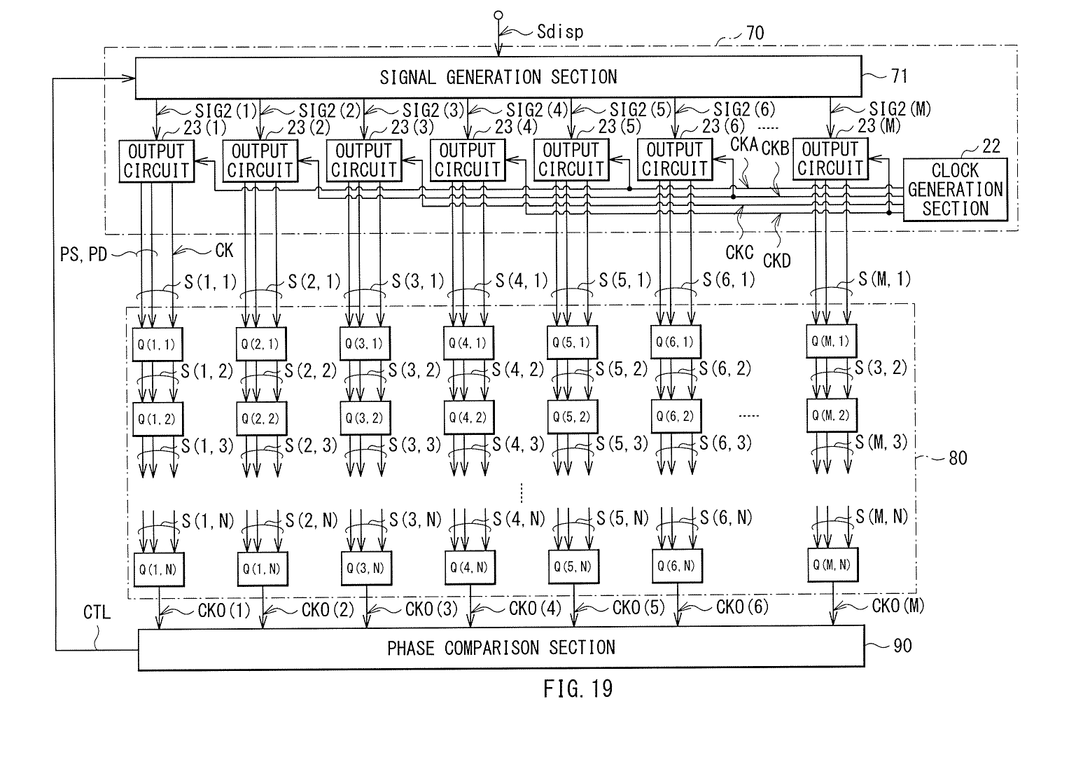

FIG. 19 illustrates a configuration example of the display panel 17. The display drive section 70 includes a signal generation section 71. The signal generation section 71 is configured to generate and output a plurality of signals SIG2(1) to SIG2(M), based on the image signal Sdisp and a control signal CTL. The respective signals SIG2(1) to SIG2(M) correspond to respective M number of pixel columns of the display section, and each include the luminance data ID and delay data DD (that will be described later) of pixels Q belonging to respective pixel columns. The display drive section 70 operate, based on the clock signals CKA to CKD of four phases; therefore, as with the above-described first embodiment (refer to FIG. 3), for example, the clock signal CK(1, 1) in the signal S(1, 1) is about 90° out of phase with the clock signal CK(2, 1) in the signal S(2, 1), the clock signal CK(2, 1) in the signal S(2, 1) is about 90° out of phase with the clock signal CK(3, 1) in the signal S(3, 1), the clock signal CK(3, 1) in the signal S(3, 1) is about 90° out of phase with the clock signal CK(4, 1) in the signal S(4, 1), and the clock signal CK(4, 1) in the signal S(4, 1) is about 90° out of phase with the clock signal CK(1, 1) in the signal S(1, 1).

Each pixel Q of the display section 80 receives the data signals PS and PD and the clock signal CK from the pixel Q previous thereto, and supplies these signals to the pixel Q subsequent thereto. Then, each pixel Q reads the luminance data ID and the delay data DD (that will be described later) for that pixel Q from that data signal PD, and emits light with light emission luminance according to the luminance data ID, and delays the data signals PS and PD and the clock signal CK by a delay amount according to the delay data DD to output the delayed signals. Then, the pixel Q in a last stage outputs a clock signal CKO (CKO(1) to CKO(M)) from an output terminal CKOUT thereof.

The phase comparison section 90 is configured to compare phases of the clock signals CKO(1) to CKO(M) with one another and control a delay amount in each pixel Q so as to have desired phase differences therebetween. More specifically, as will be described later, for example, the phase comparison section 90 may generate delay data DD of each pixel Q so as to allow the clock signal CKO(1) to be about 90° out of phase with the clock signal CKO(2), so as to allow the clock signal CKO(2) to be about 90° out of phase with the clock signal CKO(3), so as to allow the clock signal CKO(3) to be about 90° out of phase with the clock signal CKO(4), and so as to allow the clock signal CKO(4) to be about 90° out of phase with the clock signal CKO(1). In other words, the phase comparison section 90 generates the delay data DD so as to allow a phase relationship between the clock signals CK(1, 1) to CK(M, 1) input to the display section 30 to be equal to a phase relationship between the clock signals CKO(1) to CKO(M) output from the display section corresponding to the clock signals CK(1, 1) to CK(M, 1), respectively. In other words, the phase comparison section 90 generates the delay data DD so as to allow delay amounts of respective pixel columns to be equal to one another. Then, the phase comparison section 90 supplies the generated delay data DD of each pixel Q to the signal generation section 71 with use of the control signal CTL.

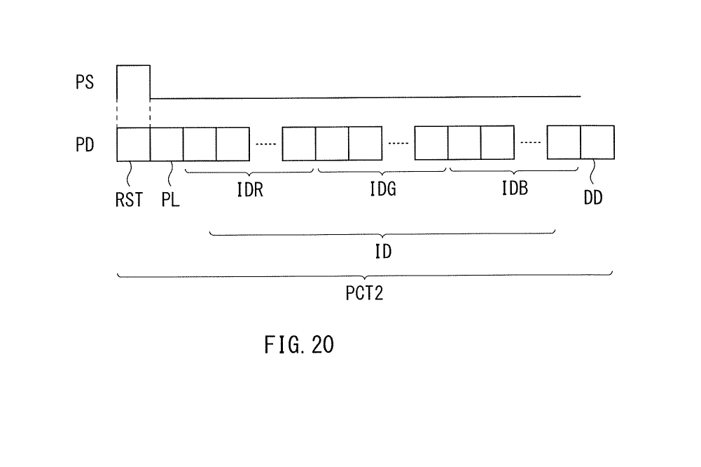

FIG. 20 illustrates a configuration example of the data signal PD according to this embodiment. A pixel packet PCT2 for one pixel Q includes the delay data DD in addition to the flag RST, the flag PL, and the luminance data ID. The delay data DD is configured to define the delay amount in each pixel Q. In this example, the delay data DD is a data of 1 bit. In this example, the delay data DD is arranged subsequent to the luminance data ID in the pixel packet PCT2.

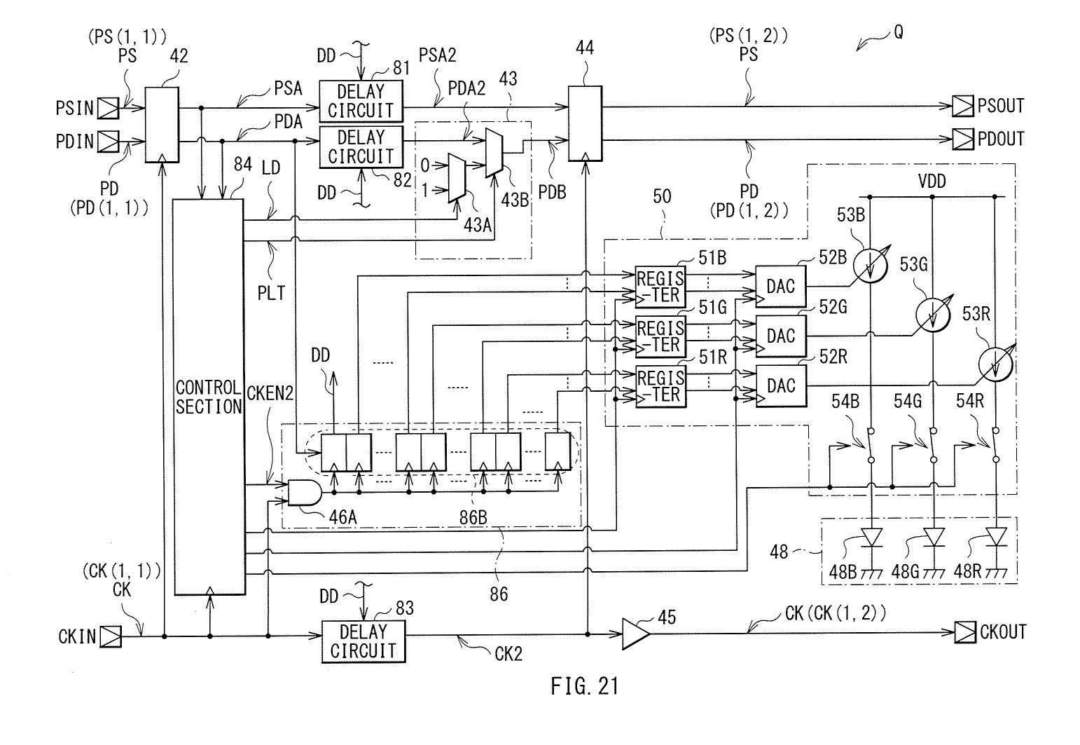

FIG. 21 illustrates a configuration example of the pixel Q. It is to be noted that, for convenience of description, the pixel Q(1, 1) will be described below as an example; however, other pixels Q are similar to the pixel Q(1, 1). The pixel Q includes a memory section 86, a control section 84, and delay circuits 81 to 83.

The memory section 86 includes a shift register 86B. In this example, the shift register 86B is a 37-bit shift register, and is configured to hold the luminance data ID of 36 bits and the delay data DD of 1 bit. More specifically, the shift register 86B is configured to hold the luminance data IDR of 12 bits, the luminance data IDG of 12 bits, the luminance data IDB of 12 bits, and the delay data DD of 1 bit from a last portion thereof.

The control section 84 has a function similar to that of the control section 41 according to the above-described first embodiment. The control section 84 is configured to generate a signal CKEN2. The signal CKEN2 is a signal that is turned to be “1” in a period of 37 bits in total in which the data signal PDA indicates the luminance data ID of 36 bits and the delay data DD of 1 bit for the pixel Q(1, 1), and is turned to “0” in other periods.

Each of the delay circuits 81 to 83 is a circuit configured to delay an input signal by a delay amount according to the delay data DD stored in the shift register 86B and output the delayed signal. More specifically, for example, each of the delay circuits 81 to 83 may increase the delay amount in a case where the delay data DD is “1”, and may decrease the delay amount in a case where the delay data DD is “0”. The delay circuit 81 delays the data signal DPA supplied from the flip-flop 42 to output the delayed data signal DPA as a data signal PDA2, and then supplies the data signal PDA2 to the selector section 43. The delay circuit 82 delays the data signal PSA supplied from the flip-flop 42 to output the delayed data signal PSA as a data signal PSA2, and supplies the data signal PSA2 to the flip-flop 44. The delay circuit 83 delays the clock signal CK input to an input terminal CKIN thereof to output the delayed clock signal CK as a clock signal CK2, and then supplies the clock signal CK2 to the buffer 45. The flip-flop 44 is configured to operate, based on the clock signal CK2 output from the delay circuit 83.

The pixel Q corresponds to a specific example of “unit pixel” in an embodiment of the present disclosure. The pixels Q(1, 1) to Q(M, 1) correspond to specific examples of “first unit pixel” in an embodiment of the present disclosure, and pixels Q(1, N) to Q(M, N) correspond to specific examples of “second unit pixel” in an embodiment of the present disclosure.

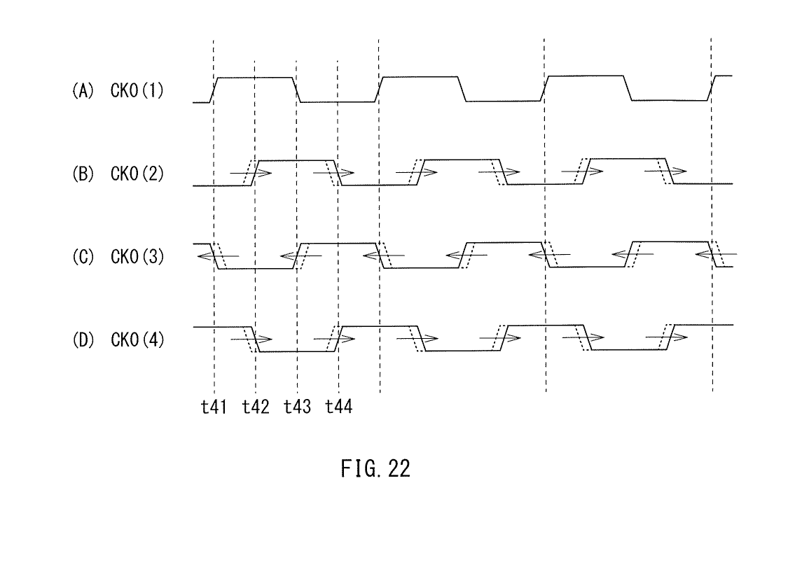

FIG. 22 illustrates an operation example of the phase comparison section 90, where parts (A) to (D) indicate waveforms of the clock signals CKO(1) to CKO(4), respectively. It is to be noted that the clock signals CKO(1) to CKO(4) will be described below as an example; however, other clock signals CKO(5) to CKO(M) are similar to the clock signals CKO(1) to CKO(4). First, the phase comparison section 90 compares the phases of the clock signals CKO(1) to CKO(M) with one another. Then, for example, as illustrated in the part (B) in FIG. 22, when a phase difference between the clock signals CKO(1) and CKO(2) is about 90° or less, the phase comparison section 90 sets the delay data DD of each pixel Q so as to delay the clock signal CKO(2). Moreover, for example, as illustrated in the part (C) in FIG. 22, when a phase difference between the clock signals CKO(1) and CKO(3) is about 180° or more, the phase comparison section 90 sets the delay data DD of each pixel Q so as to move up the phase of the clock signal CKO(3). Further, for example, as illustrated in the part (D) in FIG. 22, when a phase difference between the clock signals CKO(1) and CKO(4) is about 270° or less, the phase comparison section 90 sets the delay data DD of each pixel Q so as to delay the phase of the clock signal CKO(4). Thus, the phase comparison section 90 generates the delay data DD Of each pixel Q so as to allow the clock signal CKO(1) to be about 90° out of phase with the clock signal CKO(2), so as to allow the clock signal CKO(2) to be about 90° out of phase with the clock signal CKO(3), so as to allow the clock signal CKO(3) to be about 90° out of phase with the clock signal CKO(4), and so as to allow the clock signal CKO(4) to be about 90° out of phase with the clock signal CKO(1). Then, the phase comparison section 90 supplies these delay data DD to the signal generation section 71 with use of the control signal CTL.

Thus, in the display unit 2, the phases of the clock signals CKO(1) to CKO(M) are compared with one another, and the delay data DD is set, based on a comparison result; therefore, for example, even in a case where variation in the delay amount in each pixel Q in the display section 80 is caused by a manufacturing process, a possibility that the pixel Q malfunctions is allowed to be reduced, and a possibility that image quality of the display unit 2 is deteriorated is allowed to be reduced. In other words, for example, in the display unit 1 according to the above-described first embodiment, in a case where variation in the delay amount in each pixel column is caused by a manufacturing process, a distribution of transition timings may not be as illustrated in FIG. 8, and the transition timings may be concentrated on a certain period. In such a case, fluctuation of the power supply level or the ground level may be increased to cause malfunction in the pixel P, thereby causing deterioration in image quality of the display unit 1. On the other hand, in the display unit 2, the phases of the clock signals CKO(1) to CKO(M) are compared with one another, and the delay data DD is set, based on a comparison result; therefore, even if variation in the delay amount in each pixel column is caused by a manufacturing process, the delay data DD is allowed to be set so as to cancel out variation in the delay amount. Therefore, in the display unit 2, a possibility that transition timings are concentrated on a certain period is allowed to be reduced; therefore, fluctuation of the power supply level or the ground level is allowed to be reduced. Therefore, a possibility that the pixel Q malfunctions is allowed to be reduced, and a possibility that the image quality of the display unit is deteriorated is allowed to be reduced accordingly.

As described above, in this embodiment, the delay amount of each pixel is allowed to be changed; therefore, even in a case where variation in the delay amount in each pixel is caused by a manufacturing process, a possibility that the pixel malfunctions is allowed to be reduced, and a possibility that image quality of the display unit is deteriorated is allowed to be reduced.

### Modification Example 2-1

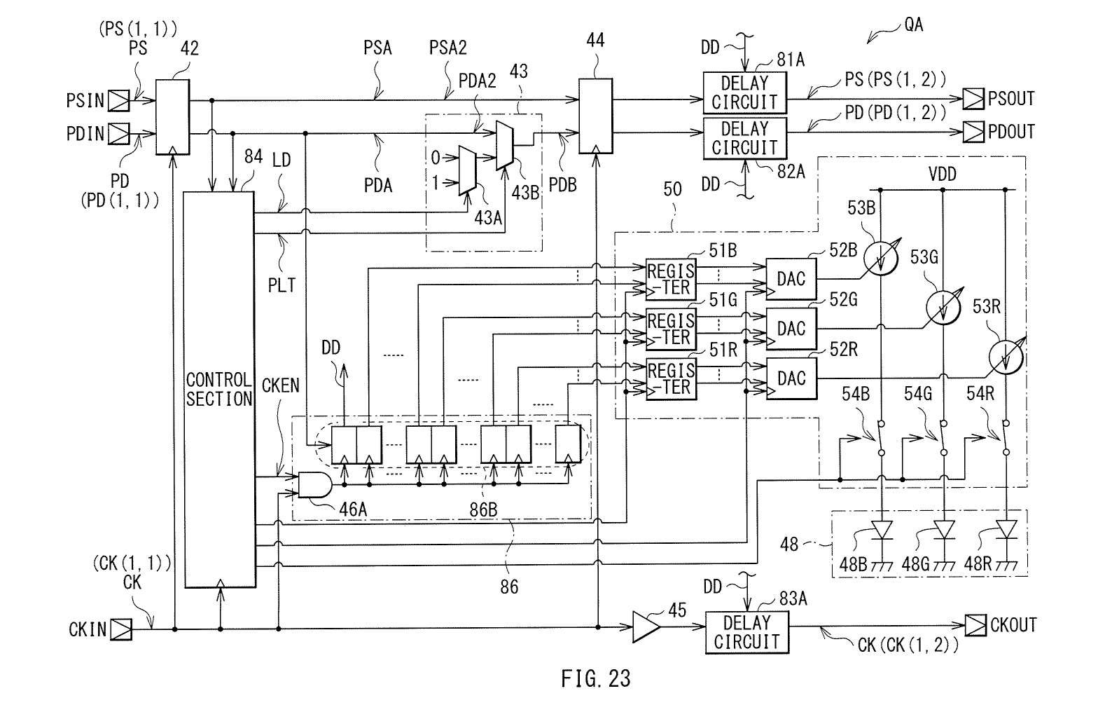

In the above-described embodiment, the delay circuit 81 is provided between the flip-flop 42 and the flip-flop 44, the delay circuit 82 is provided between the flip-flop 42 and the selector section 43, and the delay circuit 83 is provided between the input terminal CKIN and the buffer 45; however, positions of the delay circuits are not limited thereto. Alternatively, for example, in a pixel QA illustrated in FIG. 23, a delay circuit 81A may be provided between the flip-flop 44 and the output terminal PSOUT, a delay circuit 82A may be provided between the flip-flop 44 and the output terminal PDOUT, and a delay circuit 83A may be provided between the buffer 45 and the output terminal CKOUT.

### Modification Example 2-2

In the above-described embodiment, the phase comparison section 90 is provided, and the phase comparison section 90 compares the phases of the clock signals CKO(1) to CKO(M) with one another, and sets the delay data DD, based on a comparison result; however, this embodiment is not limited thereto, and the phase comparison section 90 may not be provided. A display unit 2B according to this modification example will be described in detail below.

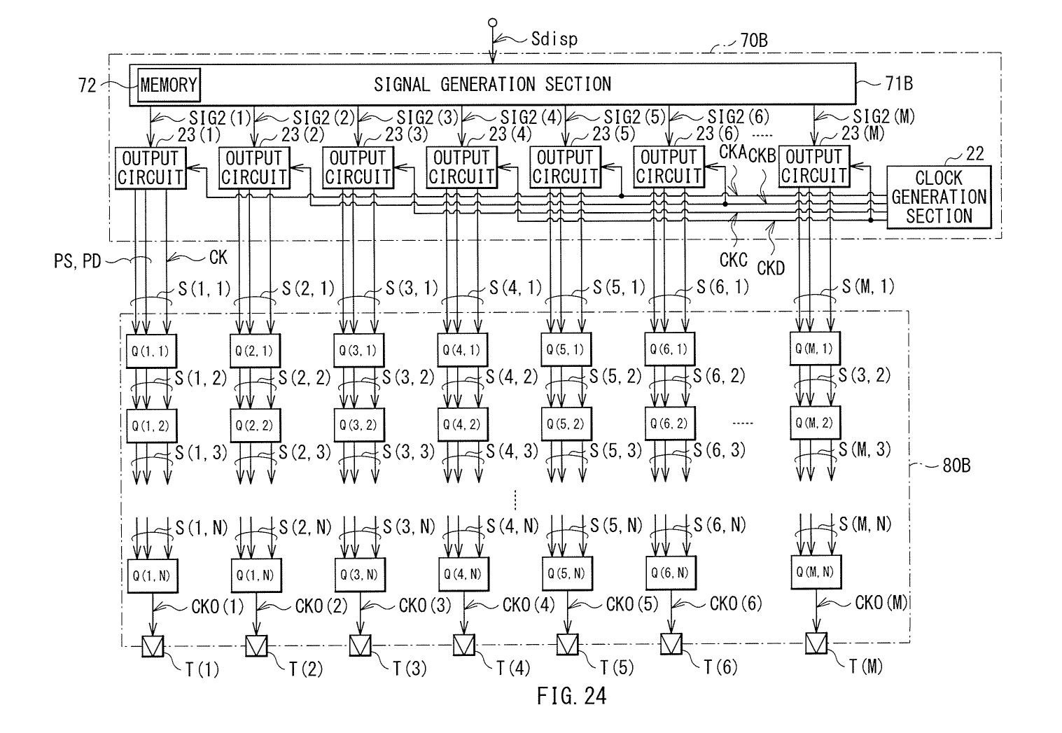

FIG. 24 illustrates a configuration example of a display panel 17B of the display unit 2B. The display panel 17B includes a display drive section 70B and a display section 80B. The display drive section 70B includes a signal generation section 71B including a memory 72. The memory 72 is configured to hold the delay data of each pixel Q. The display section 80B includes output terminals T(1) to T(M) configured to output clock signals CKO(1) to CKO(M). Each of the output terminals T(1) to T(M) may be configured of, for example, a pad, a connector, or the like, and may be allowed to be connected to an external unit, for example, during manufacturing of the display panel 17B.

By this configuration, the display panel 17B is allowed to set the delay data DD during manufacturing. In other words, during manufacturing, the display panel 17B operates once, and compares phases of the clock signals CKO(1) to CKO(M) with one another with use of an external unit such as a tester to determine the delay data DD, based on a comparison result, and then stores the delay data DD in the memory 72 in advance. Then, during a normal operation, the signal generation section 71B of the display panel 17B generates signals SIG2(1) to SIG2(M) including the luminance data ID and the delay data DD, based on the delay data DD stored in the memory 72.

Thus, in the display unit 2B, even in a case where variation in each pixel is caused by a manufacturing process, the variation may be corrected in advance during manufacturing. Therefore, in the display unit 2B, as with the above-described embodiment, a possibility that pixel Q malfunctions is allowed to be reduced, and a possibility that image quality of the display unit 2B is deteriorated is allowed to be reduced.

### Modification Example 2-3

In the above-described embodiment, the memory section 86 holds the delay data DD in addition to the luminance data ID; however, this embodiment is not limited thereto. A display unit 2C according to this modification example will be described below.

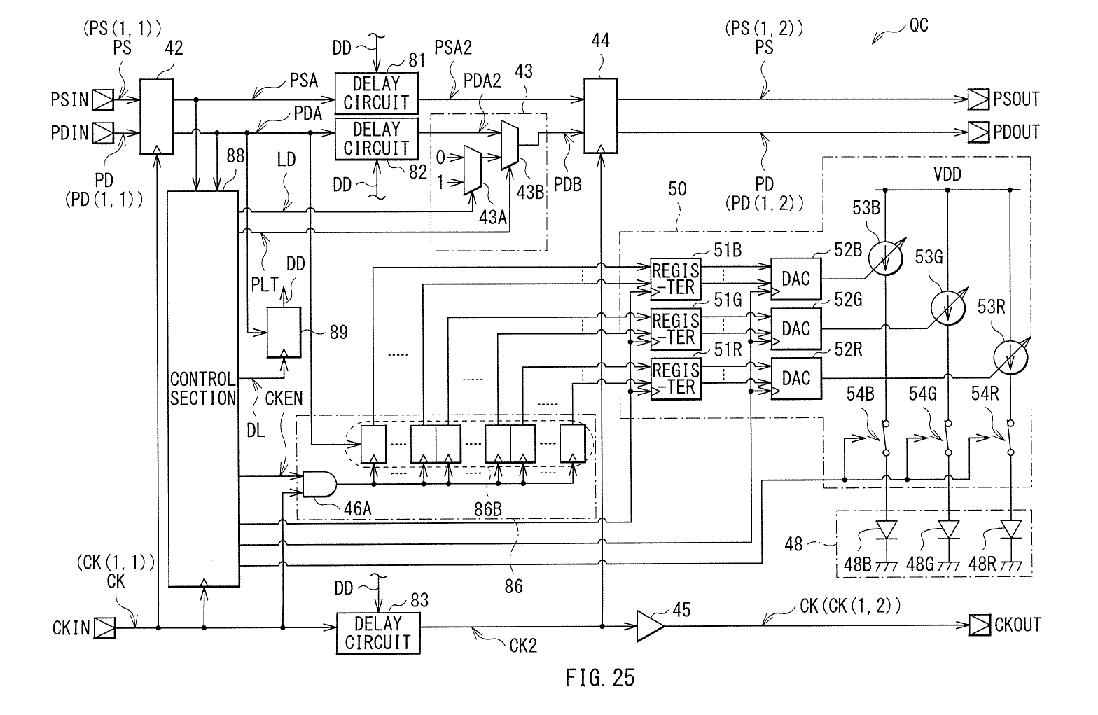

FIG. 25 illustrates a configuration example of a pixel QC of the display unit 2C. It is to be noted that, for convenience of description, a pixel QC(1, 1) will be described below as an example; however, other pixels QC are similar to the pixel QC(1, 1). The pixel QC includes a register 89 and a control section 88. The register 89 is configured to hold the delay data DD of 1 bit for the pixel QC(1, 1) included in the data signal PDA. The control section 88 has a function similar to that of the control section 41 according to the above-described first embodiment. The control section 88 also has a function of generating a signal DL. The signal DL is a signal indicating, to the register 89, a timing of holding the delay data DD for the pixel QC(1, 1) included in the data signal PDA.

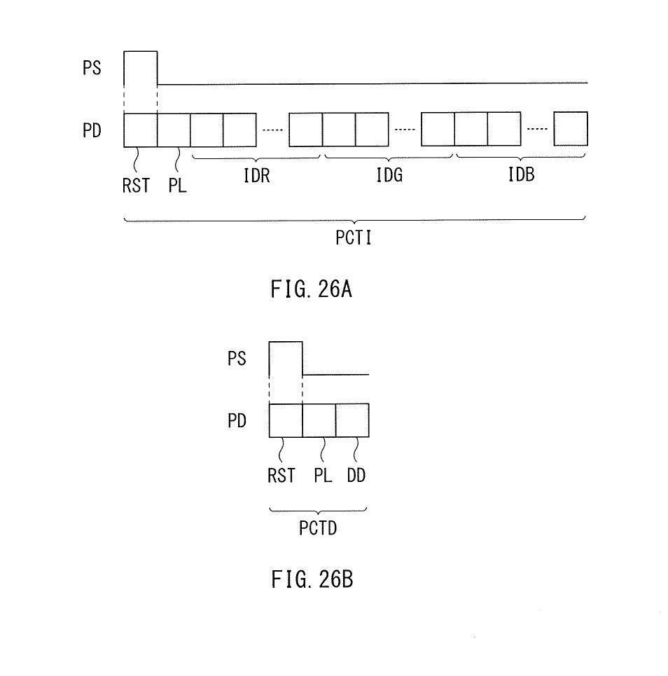

FIGS. 26A and 26B illustrate a configuration example of the data signals PS and PD generated by the display drive section 70C in the display unit 2C, and FIG. 26A illustrates a luminance data packet PCTI for transmission of the luminance data ID to each pixel QC, and FIG. 26B illustrates a delay data packet PCTD for transmission of the delay data DD to each pixel QC. The luminance data packet PCTI is similar to the pixel packet PCT according to the above-described first embodiment. The delay data packet PCTD includes the flag RST, the flag PL, and the delay data DD.

By this configuration, in the display unit 2C, the display drive section 70C supplies the luminance data packet PCTI to the pixel QC during a normal operation, and supplies the delay data packet PCTD to the pixel QC, for example, on power activation, in a blanking period, and the like. Therefore, for example, compared to a case where the pixel packet PCT2 is supplied to the pixel Q as with the above-described embodiment, a data amount that is to be supplied is allowed to be reduced, an operation frequency is allowed to be reduced, and power consumption is allowed to be reduced.

### Modification Example 2-4

In the above-described embodiment, the delay circuits 81 to 83 are provided to each pixel Q; however, the embodiment is not limited thereto. Alternatively, the delay circuits 81 to 83 may not be provided to all pixels. More specifically, for example, in each pixel column, the pixels Q including the delay circuits 81 to 83 and the pixels P not including the delay circuits 81 to 83 may be alternately arranged.

### Modification Example 2-5

Any of Modification Examples 1-1 to 1-5 may be applied to the display unit 2 according to the above-described embodiment.

Although the present technology is described referring to the embodiments and the modification examples thereof, the present technology is not limited thereto, and may be variously modified.

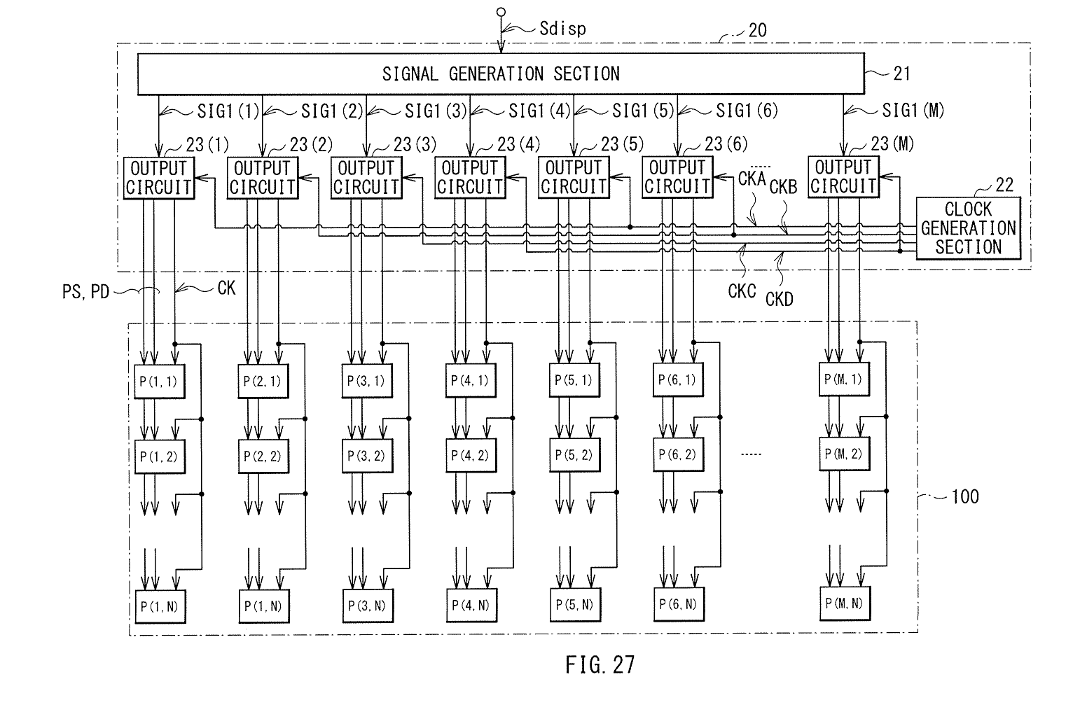

For example, in the above-described embodiments and the like, while the pixels P and Q are connected in a daisy chain fashion with respect to the data signals PS and PD, and are connected in a daisy chain fashion with respect to the clock signal CK; however, the present technology is not limited thereto. Alternatively, for example, as illustrated in FIG. 27, the pixels P and Q may be connected in a daisy chain fashion only with respect to the data signals PS and PD. FIG. 27 illustrates this modification example that is applied to the above-described first embodiment. In this case, the display drive section 20 is allowed to supply the clock signal CK to each pixel P through, for example, global wiring.

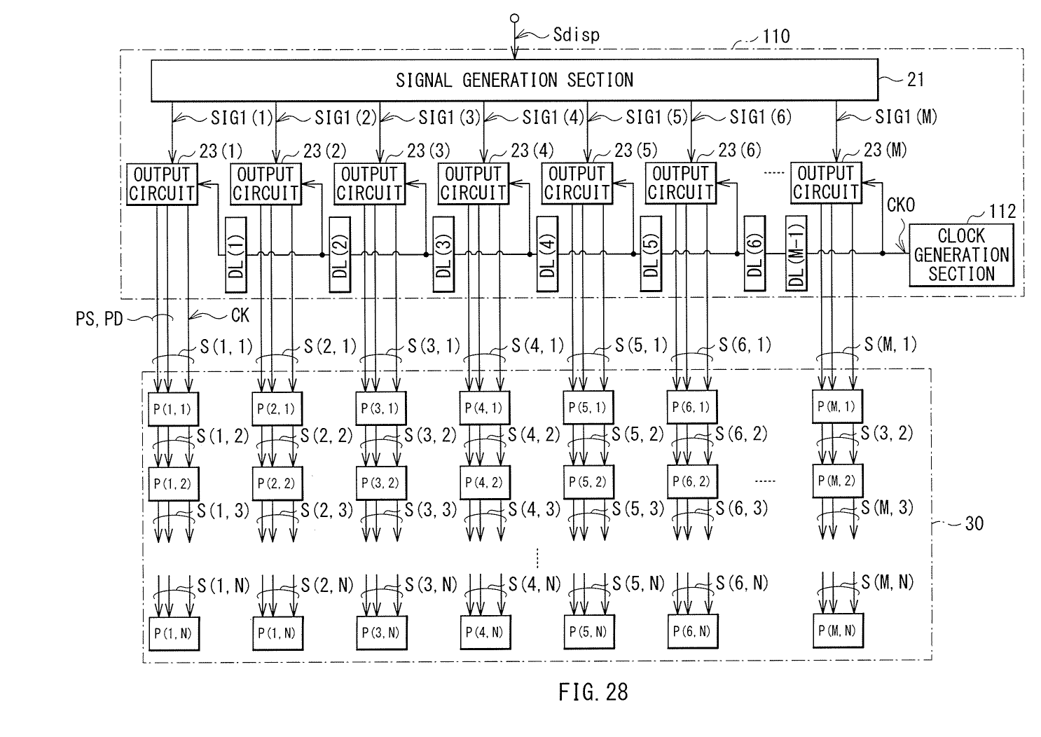

Moreover, for example, in the above-described embodiments and the like, the clock generation section 22 that generates a multiphase clock signal is provided; however, the present technology is not limited thereto. Alternatively, for example, as illustrated in FIG. 28, a clock generation section 112 configured to generate one clock signal CK0 and a plurality of delay circuits DL(1) to DL(M−1) may be provided. In this example, the clock generation section 112 supplies the clock signal CK0 to the output circuit 23(M) and the delay circuit DL(M−1). The delay circuit DL(M−1) delays the clock signal CK0 by a predetermined amount to supply the delayed clock signal to the output circuit 23(M−1) and the delay circuit DL(M−2). The delay circuit DL(M−2) delays the clock signal supplied from the delay circuit DL(M−1) by a predetermined amount to supply the delayed clock signal to the output circuit 23(M−2) and the delay circuit DL(M−3). This is applicable to the delay circuit DL(M−3) to DL(2). Then, the delay circuit DL(1) delays a clock signal supplied from the delay circuit DL(2) by a predetermined amount to supply the delayed clock signal to the output circuit 23(1).

Further, in the above-described embodiments and the like, the LED is used as a display device; however, the present technology is not limited thereto. Alternatively, an organic EL device may be used as a display device.

Furthermore, in the above-described embodiments and the like, the present technology is applied to a television; however, the present technology is not limited thereto, and is applicable to various apparatuses that display an image. More specifically, the present technology may be applied to a large-screen display installed in a soccer field, a baseball stadium, and the like.

It is to be noted that the present technology may have the following configurations.

(1) A display panel including:

a display section including a plurality of unit pixels; and

a display drive section configured to generate a plurality of clock signals and supply the clock signals to the display section, the clock signals including two or more clock signals with phases different from one another.

(2) The display panel according to (1), in which

the display drive section includes a multiphase clock generation section configured to generate two or more reference clock signals with phases different from one another, and

each of the plurality of clock signals corresponds to one of the two or more reference clock signals.

(3) The display panel according to (1) or (2), in which

the plurality of unit pixels are grouped into a plurality of unit pixel groups each having a predetermined number of unit pixels, the plurality of unit pixel groups being provided corresponding to the respective plurality of clock signals,

each of the unit pixels includes a display device, a clock input terminal, and a clock output terminal,

one of the plurality of clock signals is supplied from the display drive section to the clock input terminal of a first unit pixel of the predetermined number of unit pixels, and

the clock input terminal of one unit pixel other than the first unit pixel of the predetermined unit pixels is connected to the clock output terminal of another unit pixel of the predetermined number of unit pixels.

(4) The display panel according to (3), in which one or more of the predetermined number of unit pixels include a delay circuit provided on a signal path from the clock input terminal to the clock output terminal, the delay circuit configured to allow a delay amount to be changed.

(5) The display panel according to (4), in which

the display drive section also generates a plurality of data signals corresponding to the plurality of clock signals,

each of the unit pixels further includes a data input terminal and a data output terminal,

one of the plurality of data signals is supplied from the display drive section to the data input terminal of the first unit pixel, and

the data input terminal of one unit pixel other than the first unit pixel of the predetermined number of unit pixels is connected to the data output terminal of another unit pixel of the predetermined number of unit pixels.

(6) The display panel according to (5), in which each of the data signals includes luminance data and delay data, the luminance data configured to define luminance of the display device, and the delay data configured to define delay amount of the delay circuit.

(7) The display panel according to (6), further including a phase comparison section configured to compare phases of clock signals output from the respective clock output terminals of respective second unit pixels with one another, each of the second unit pixels being a last stage of corresponding one of the plurality of unit pixel groups.

(8) The display panel according to (7), in which the phase comparison section determines the delay data, based on a comparison result.

(9) The display panel according to (6), further including external terminals configured to allow an external unit to detect clock signals output from the respective clock output terminals of respective second unit pixels, each of the second unit pixels being a last stage of corresponding one of the plurality of unit pixel groups.

(10) The display panel according to (9), in which the display drive section includes a memory configured to hold delay data.

(11) The display panel according to (1) or (2), in which

the plurality of unit pixels are grouped into a plurality of unit pixel groups each having a predetermined number of unit pixels, the plurality of unit pixel groups being provided corresponding to the respective plurality of clock signals,

each of the unit pixels includes a clock input terminal, and

the clock input terminals of the respective unit pixels in each of the unit pixel groups are supplied with corresponding one of the plurality of clock signals.

(12) The display panel according to any one of (3) to (11), in which

each of the clock signals is a differential signal configured of a first clock signal and a second clock signal,

the clock input terminal is configured of a first clock input terminal corresponding to the first clock signal and a second clock input terminal corresponding to the second clock signal, and

the clock output terminal is configured of a first clock output terminal corresponding to the first clock signal and a second clock output terminal corresponding to the second clock signal.

(13) The display panel according to any one of (5) to (12), in which each of the data signal is a digital signal.

(14) The display panel according to any one of (3) to (13), in which the display device is an LED display device.

(15) The display panel according to (1), in which t the display drive section includes one or more of delay circuits configured to define a phase difference between the two or more clock signals.

(16) A driving method including:

generating a plurality of clock signals, the clock signals including two or more clock signals with phases different from one another; and

supplying the plurality of clock signals to the display section including a plurality of unit pixels.

(17) An electronic apparatus provided with a display panel and a control section, the control section configured to perform operation control on the display panel, the display panel including:

a display section including a plurality of unit pixels; and

a display drive section configured to generate a plurality of clock signals and supply the clock signals to the display section, the clock signals including two or more clock signals with phases different from one another.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display panel comprising:
a display section including a plurality of unit pixels; and
a display drive section configured to generate a plurality of clock signals and supply the clock signals to the display section, the clock signals including two or more clock signals with phases different from one another.

2. The display panel according to claim 1, wherein
the display drive section includes a multiphase clock generation section configured to generate two or more reference clock signals with phases different from one another, and
each of the plurality of clock signals corresponds to one of the two or more reference clock signals.

3. The display panel according to claim 1, wherein
the plurality of unit pixels are grouped into a plurality of unit pixel groups each having a predetermined number of unit pixels, the plurality of unit pixel groups being provided corresponding to the respective plurality of clock signals,
each of the unit pixels includes a display device, a clock input terminal, and a clock output terminal,
one of the plurality of clock signals is supplied from the display drive section to the clock input terminal of a first unit pixel of the predetermined number of unit pixels, and
the clock input terminal of one unit pixel other than the first unit pixel of the predetermined unit pixels is connected to the clock output terminal of another unit pixel of the predetermined number of unit pixels.

4. The display panel according to claim 3, wherein one or more of the predetermined number of unit pixels include a delay circuit provided on a signal path from the clock input terminal to the clock output terminal, the delay circuit configured to allow a delay amount to be changed.

5. The display panel according to claim 4, wherein
the display drive section also generates a plurality of data signals corresponding to the plurality of clock signals,
each of the unit pixels further includes a data input terminal and a data output terminal,
one of the plurality of data signals is supplied from the display drive section to the data input terminal of the first unit pixel, and
the data input terminal of one unit pixel other than the first unit pixel of the predetermined number of unit pixels is connected to the data output terminal of another unit pixel of the predetermined number of unit pixels.

6. The display panel according to claim 5, wherein each of the data signals includes luminance data and delay data, the luminance data configured to define luminance of the display device, and the delay data configured to define a delay amount of the delay circuit.

7. The display panel according to claim 6, further comprising a phase comparison section configured to compare phases of clock signals output from the respective clock output terminals of respective second unit pixels with one another, each of the second unit pixels being a last stage of corresponding one of the plurality of unit pixel groups.

8. The display panel according to claim 7, wherein the phase comparison section determines the delay data, based on a comparison result.

9. The display panel according to claim 6, further comprising external terminals configured to allow an external unit to detect clock signals output from the respective clock output terminals of respective second unit pixels, each of the second unit pixels being a last stage of corresponding one of the plurality of unit pixel groups.

10. The display panel according to claim 9, wherein the display drive section includes a memory configured to hold delay data.

11. The display panel according to claim 1, wherein
the plurality of unit pixels are grouped into a plurality of unit pixel groups each having a predetermined number of unit pixels, the plurality of unit pixel groups being provided corresponding to the respective plurality of clock signals,
each of the unit pixels includes a clock input terminal, and
the clock input terminals of the respective unit pixels in each of the unit pixel groups are supplied with corresponding one of the plurality of clock signals.

12. The display panel according to claim 3, wherein
each of the clock signals is a differential signal configured of a first clock signal and a second clock signal,
the clock input terminal is configured of a first clock input terminal corresponding to the first clock signal and a second clock input terminal corresponding to the second clock signal, and
the clock output terminal is configured of a first clock output terminal corresponding to the first clock signal and a second clock output terminal corresponding to the second clock signal.

13. The display panel according to claim 5, wherein each of the data signal is a digital signal.

14. The display panel according to claim 3, wherein the display device is an LED display device.

15. The display panel according to claim 1, wherein the display drive section includes one or more of delay circuits configured to define a phase difference between the two or more clock signals.

16. A driving method comprising:
generating a plurality of clock signals, the clock signals including two or more clock signals with phases different from one another; and
supplying the plurality of clock signals to the display section including a plurality of unit pixels.

17. An electronic apparatus provided with a display panel and a control section, the control section configured to perform operation control on the display panel, the display panel comprising:
a display section including a plurality of unit pixels; and
a display drive section configured to generate a plurality of clock signals and supply the clock signals to the display section, the clock signals including two or more clock signals with phases different from one another.
